(19) United States
(12) Patent Application Publication
(10) Pub. No.: US 2026/0113122 A1
(43) Pub. Date: Apr. 23, 2026

(54) DIFFERENTIAL QPSK ENCODING AND DECODING

(71) Applicant: Attltude, Inc., Menlo Park, CA (US)

(72) Inventors: Tom Welch, Menlo Park, CA (US); Rene Schmograw, Menlo Park, CA (US); Richard Chan, Menlo Park, CA (US); Joy Laskar, Mountain View, CA (US); David F. Welch, Atherton, CA (US)

(21) Appl. No.: 19/364,446

(22) Filed: Oct. 21, 2025

Related U.S. Application Data
(60) Provisional application No. 63/709,812, filed on Oct. 21, 2024.

(51) Int. Cl. H04B 10/556; H04B 10/25; H04B 10/40

(52) U.S. Cl. CPC H04B 10/5561; H04B 10/25; H04B 10/40

(57) ABSTRACT

Systems and methods are disclosed herein, including a method, comprising: (a) receiving, with a differential quadrature phase shift keying (DQPSK) encoder of a radio frequency (RF) transmitter, an input digital bitstream encoded in reflected binary code (RBC) and comprising first symbols; (b) receiving a first symbol of the first symbols; (c) storing the first symbol in the memory as a previous symbol; (d) receiving a second symbol of the first symbols as a current symbol; (e) converting the current symbol and the previous symbol into natural binary code (NBC); (f) adding the current symbol and the previous symbol to produce a particular second symbol; (g) converting the particular second symbol into RBC; (h) storing the current symbol in the memory as the previous symbol; and (i) repeating steps (d)-(h) for each of the first symbols to produce a DQPSK-encoded digital bitstream having the second symbols encoded in RBC.

### INCORPORATION BY REFERENCE

The present patent application claims priority to the patent application identified by U.S. Ser. 63/709,812 filed on Oct. 21, 2024, all of which is hereby incorporated herein by reference.

### BACKGROUND ART

Optical networking is a means of communication that uses signals encoded in light to transmit information in various types of telecommunications networks, including limited range local-area networks (LANs) or wide-area networks (WANs). It is a form of optical communication that relies on optical amplifiers, lasers, or LEDs and wavelength-division multiplexing (WDM) to transmit large quantities of data, generally across fiber-optic cables. Because it is capable of achieving extremely high bandwidth, it is an enabling technology for the Internet and telecommunication networks that transmit the vast majority of all human and machine-to-machine information. However, further development and optimization of optical networking systems face certain limiting factors, namely, power dissipation, thermal requirements, and mechanical tolerances.

Optical components generate photons by exciting electrons in a gain medium, and the electrons emit photons as they return to lower energy levels. Despite efforts to improve efficiency, optical components generate some amount of heat during the electron excitation process, and such heat is referred to as power dissipation. Excessive power dissipation may lead to thermal management problems and may affect the performance and longevity of the optical components.

Optical components are sensitive to temperature fluctuations and often require lower operating temperatures than purely electronic components to maintain optimal performance. Elevated temperatures may result in increased signal noise, diminished signal quality, and reduced service life for optical components. Accordingly, optical components often require cooling systems (e.g., heat sinks, fans, or thermoelectric devices) to dissipate excess heat and maintain the optical components within a safe temperature range.

Optical networking systems typically operate in micrometer wavelengths, demanding extreme precision in component fabrication, assembly, and alignment. Even slight deviations from the required mechanical tolerances may lead to signal degradation, loss, or the introduction of optical crosstalk, negatively impacting network performance. Achieving and maintaining the necessary mechanical tolerances necessitates advanced manufacturing techniques and stringent quality control measures.

### SUMMARY OF THE INVENTION

In one implementation, the present disclosure includes a radio frequency (RF) transmitter, comprising: an input interface configured to receive an input digital bitstream encoded in a reflected binary code, the reflected binary code being an encoding of numbers such that successive numbers differ by only one bit, the input digital bitstream comprising a first plurality of symbols; a differential quadrature phase shift keying (DQPSK) encoder having a memory, the DQPSK encoder configured to: (a) receive a first symbol of the first plurality of symbols; (b) store the first symbol in the memory as a previous symbol; (c) receive a second symbol of the first plurality of symbols as a current symbol; (d) convert the current symbol and the previous symbol into a natural binary code; (e) add the current symbol and the previous symbol to produce a particular one of a second plurality of symbols; (f) convert the particular one of the second plurality of symbols into the reflected binary code; and (g) store the current symbol in the memory as the previous symbol; and (h) repeat steps (c)-(g) for each of the first plurality of symbols to produce a DQPSK-encoded digital bitstream having the second plurality of symbols encoded in the reflected binary code; circuitry configured to generate a transmission signal based on the DQPSK-encoded digital bitstream, wherein the transmission signal is an RF signal having a frequency in a range between 300 Gigahertz (GHz) and 10 Terahertz (THz); and an antenna configured to transmit the transmission signal.

In another implementation, the present disclosures includes a radio frequency (RF) receiver, comprising: an antenna configured to receive a transmission signal, wherein the transmission signal is an RF signal having a frequency in a range between 300 Gigahertz (GHz) and 10 Terahertz (THz); circuitry configured to generate a differential quadrature phase shift keying (DQPSK)-encoded digital bitstream based on the transmission signal, the DQPSK-encoded digital bitstream encoded in a reflected binary code and comprising a first plurality of symbols, the reflected binary code being an encoding of numbers such that successive numbers differ by only one bit; a DQPSK decoder having a memory, the DQPSK decoder configured to: (a) receive a previous symbol of the first plurality of symbols; (b) store the previous symbol in the memory; (c) receive a current symbol of the first plurality of symbols; (d) convert the current symbol and the previous symbol into a natural binary code; (e) subtract the previous symbol from the current symbol to produce a particular one of a second plurality of symbols; (f) convert the particular one of the second plurality of symbols into the reflected binary code; (g) store the current symbol in the memory as the previous symbol; and (h) repeat steps (c)-(g) for each of the first plurality of symbols of the DQPSK-encoded digital bitstream to produce an output digital bitstream having the second plurality of symbols encoded in the reflected binary code; and an output interface configured to transmit the output digital bitstream.

In another implementation, the present disclosure includes a method, comprising: (a) receiving, with a differential quadrature phase shift keying (DQPSK) encoder of a radio frequency (RF) transmitter, an input digital bitstream encoded in a reflected binary code, the reflected binary code being an encoding of numbers such that successive numbers differ by only one bit, the input digital bitstream comprising a first plurality of symbols, the DQPSK encoder having a memory; (b) receiving a first symbol of the first plurality of symbols; (c) storing the first symbol in the memory as a previous symbol; (d) receiving a second symbol of the first plurality of symbols as a current symbol; (e) converting the current symbol and the previous symbol into a natural binary code; (f) adding the current symbol and the previous symbol to produce a particular one of a second plurality of symbols; (g) converting the particular one of the second plurality of symbols into the reflected binary code; (h) storing the current symbol in the memory as the previous symbol; and (i) repeating steps (d)-(h) for each of the first plurality of symbols of the input digital bitstream to produce a DQPSK-encoded digital bitstream having the second plurality of symbols encoded in the reflected binary code.

In another implementation, the present disclosure includes a method, comprising: (a) receiving, with a DQPSK decoder of a radio frequency (RF) receiver, a DQPSK-encoded digital bitstream encoded in a reflected binary code and comprising a first plurality of symbols, the reflected binary code being an encoding of numbers such that successive numbers differ by only one bit, the DQPSK decoder having a memory; (b) receiving a first symbol of the first plurality of symbols; (c) storing the first symbol in the memory as a previous symbol; (d) receiving a second symbol of the first plurality of symbols as a current symbol; (e) converting the current symbol and the previous symbol into natural binary code; (f) subtracting the previous symbol from the current symbol to produce a particular one of a second plurality of symbols; (g) converting the particular one of the second plurality of symbols into the reflected binary code; (h) storing the current symbol in the memory as the previous symbol; and (i) repeating steps (d)-(h) for each of the first plurality of symbols of the DQPSK-encoded digital bitstream to produce an output digital bitstream having the second plurality of symbols encoded in the reflected binary code.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagrammatic view of an electromagnetic (EM) spectrum;

FIG. 2 is a block diagram of an exemplary implementation of a transport network constructed in accordance with the present disclosure;

FIG. 3A is a cross-sectional view of an exemplary implementation of a first optical fiber link shown in FIG. 2, taken along a line 3A-3A′ and in the direction of the arrows, wherein the first optical fiber link is a single-mode fiber;

FIG. 3B is a cross-sectional view of an exemplary implementation of a second optical fiber link shown in FIG. 2, taken along a line 3B-3B′ and in the direction of the arrows, wherein the second optical fiber link is a multi-mode fiber;

FIG. 3C is a cross-sectional view of an exemplary implementation of a third optical fiber link shown in FIG. 2, taken along a line 3C-3C′ and in the direction of the arrows, wherein the third optical fiber link is a photonic-bandgap fiber;

FIG. 3D is a cross-sectional view of an exemplary implementation of a fourth optical fiber link shown in FIG. 2, taken along a line 3D-3D′ and in the direction of the arrows, wherein the fourth optical fiber link is an elliptical-core fiber having an optional dielectric layer, a conductive layer, and a support layer;

FIG. 3E is a cross-sectional view of another exemplary implementation of the fourth optical fiber link shown in FIG. 2, taken along a line 3D-3D′ and in the direction of the arrows, wherein the fourth optical fiber link is an elliptical-core fiber having the conductive layer and the support layer but lacking the optional dielectric layer;

FIG. 3F is a cross-sectional view of another exemplary implementation of the fourth optical fiber link shown in FIG. 2, taken along a line 3D-3D′ and in the direction of the arrows, wherein the fourth optical fiber link is an elliptical-core fiber having the optional dielectric layer and the conductive layer but lacking the support layer;

FIG. 3G is a cross-sectional view of another exemplary implementation of the fourth optical fiber link shown in FIG. 2, taken along a line 3D-3D′ and in the direction of the arrows, wherein the fourth optical fiber link is an elliptical-core fiber having the conductive layer but lacking the optional dielectric layer and the support layer;

FIGS. 3H-3S are perspective views of other exemplary implementations of the first optical fiber link shown in FIG. 3A;

FIG. 4A is a block diagram of an exemplary implementation of a first fiber-coupled RF transmitter shown in FIG. 2;

FIG. 4B is a block diagram of an exemplary implementation of a second fiber-coupled RF transmitter shown in FIG. 2;

FIG. 5A is a block diagram of an exemplary implementation of a first fiber-coupled RF receiver shown in FIG. 2;

FIG. 5B is a block diagram of an exemplary implementation of a second fiber-coupled RF receiver shown in FIG. 2;

FIG. 6A is a block diagram of an exemplary implementation of a fiber-coupled RF transceiver shown in FIG. 2;

FIG. 6B is a block diagram of another exemplary implementation of the fiber-coupled RF transceiver shown in FIG. 6A, wherein the fiber-coupled RF transceiver is a fiber-coupled multi-band RF transceiver;

FIG. 7 is a schematic diagram of a folded modulator constructed in accordance with the present disclosure;

FIG. 8 is a schematic diagram of a rectifying detector constructed in accordance with the present disclosure;

FIG. 9A is a side view of an exemplary implementation of an RF antenna constructed in accordance with the present disclosure for generating a circularly polarized RF signal;

FIG. 9B is a side view of another exemplary implementation of an RF antenna constructed in accordance with the present disclosure;

FIGS. 10A-10J are perspective views of other exemplary implementations of the RF antenna shown in FIGS. 9A and 9B;

FIG. 11 is a diagrammatic view of an exemplary implementation of a network element configured to modulate data using differential quadrature phase shift keying (DQPSK) constructed in accordance with the present disclosure;

FIG. 12A is a diagrammatic view of an exemplary implementation of a transmitter shown in FIG. 11;

FIG. 12B is a diagrammatic view of an exemplary implementation of a receiver shown in FIG. 11;

FIG. 13A is a logical view of the transmitter shown in FIG. 12A;

FIG. 13B is a logical view of the receiver shown in FIG. 12B;

FIG. 14 is a diagrammatic view of an exemplary implementation of a method of encoding data in a DQPSK format in accordance with the present disclosure; and

FIG. 15 is a diagrammatic view of an exemplary implementation of a method of decoding data from a DQPSK format in accordance with the present disclosure.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, “Phase-Shift Keying” (PSK) is a form of signal modulation in which signal data is encoded in a phase of a carrier signal having a constant frequency. “Quadrature PSK” (QPSK) Is a form of PSK in which two data bits (i.e., 00, 01, 10, or 11) are modulated at once, selecting one of four possible carrier phase shifts (i.e., 0°, 90°, 180°, or 270°). “Differential QPSK” (DQPSK) is a form of QPSK in which data bits are encoded in the change of the phase of the carrier signal from one symbol to the next.

As used herein, “reflected binary code” (RBC)—also referred to as “Gray code”—is an ordering of the binary numeral system in which any two successive numerical values differ in only one bit. For example, the range (0, 1, 2, 3, 4, 5, 6, 7, 8) in the decimal numeral system corresponds to the range (0000, 0001, 0010, 0011, 0100, 0101, 0110, 0111, 1000) in the binary numeral system and the range (0000, 0001, 0011, 0010, 0110, 0111, 0101, 0100, 1100) in the reflected binary numeral system.

Referring now to the drawings, and in particular to FIG. 1, shown therein is a diagrammatic view of an electromagnetic (EM) spectrum 100 in accordance with the present disclosure.

The present disclosure is generally related to network elements that communicate using radio frequency communications coupled into a passive waveguide. The RF communications have an electromagnetic wave with a carrier frequency in what is referred to as a Terahertz (THz) frequency band 104 (i.e., frequencies between 0.1 THz and 10 THz and wavelengths between 3 millimeters (mm) and 30 micrometers (μm)). Where certain aspects of the present disclosure are described as relating to “THz”, it should be understood that such aspects of the present disclosure relate to the THz frequency band 104.

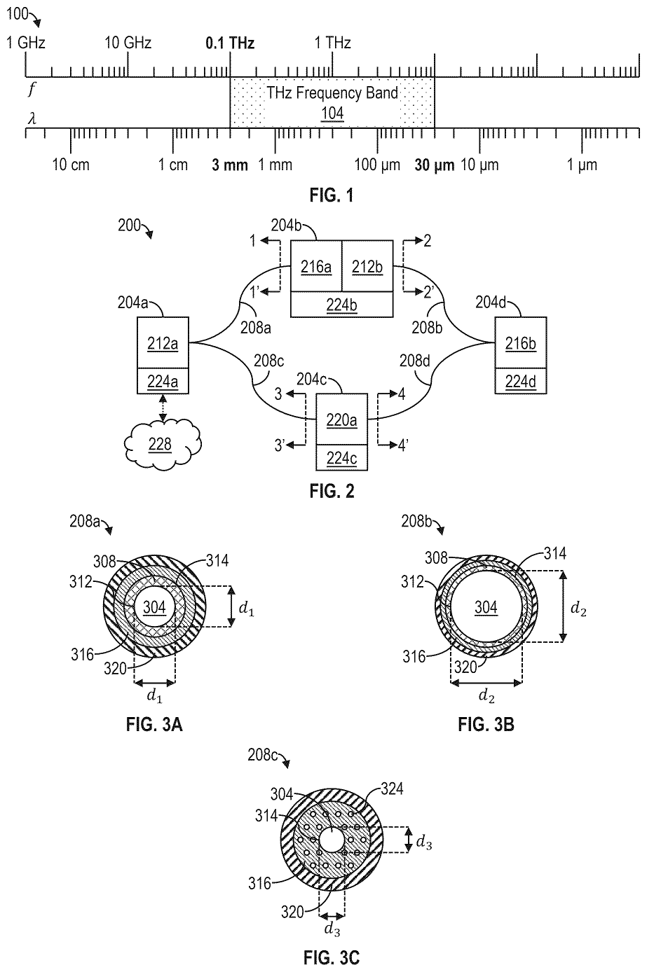

Referring now to FIG. 2, shown therein is a block diagram of an exemplary implementation of a fiber-coupled THz RF transport network 200 (hereinafter the “transport network 200”) constructed in accordance with the present disclosure.

The transport network 200 is depicted as comprising a plurality of network elements 204a-n (hereinafter the “network elements 204”) (e.g., a first network element 204a, a second network element 204b, a third network element 204c, and a fourth network element 204d shown in FIG. 2). While only four of the network elements 204 are shown in FIG. 2 for exemplary purposes, it should be understood that the transport network 200 may comprise a number of the network elements 204 that may be greater or fewer than four. In some implementations, each of the network elements 204 is an integrated circuit (IC).

The transport network 200 may further comprise one or more passive waveguide 208a-n (hereinafter the “passive waveguides 208”) (e.g., a first passive waveguide 208a, a second passive waveguide 208b, a third passive waveguide 208c, and a fourth passive waveguide 208d shown in FIG. 2). While only four of the passive waveguides 208 are shown in FIG. 2 for exemplary purposes, it should be understood that the transport network 200 may comprise a number of the passive waveguides 208 that may be greater or fewer than four. Data transmitted within the transport network 200 from the first network element 204a to the fourth network element 204d may travel along a first path formed by the first passive waveguide 208a, the second network element 204b, and the second passive waveguide 208b or a second path formed by the third passive waveguide 208c, the third network element 204c, and the fourth passive waveguide 208d.

In some implementations, each of the passive waveguides 208 is configured to provide unidirectional communication of data within the transport network 200; however, in other implementations, one or more (e.g., two) of the passive waveguides 208 may be configured to provide bidirectional communication of data within the transport network 200. In implementations where one or more of the passive waveguides 208 are configured to provide bidirectional communication of data within the transport network 200, a first data signal being transmitted in a first direction through the passive waveguide 208 may be differentiated from a second data signal being transmitted in a second direction through the passive waveguide 208 opposite the first direction by being provided with a different polarization, frequency, etc. In some such implementations, one or more circulator may be included to achieve such differentiation.

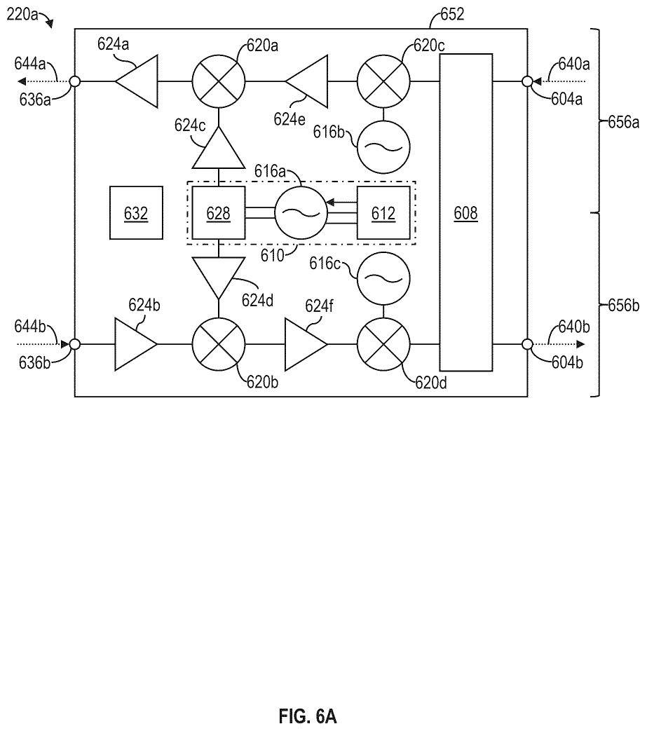

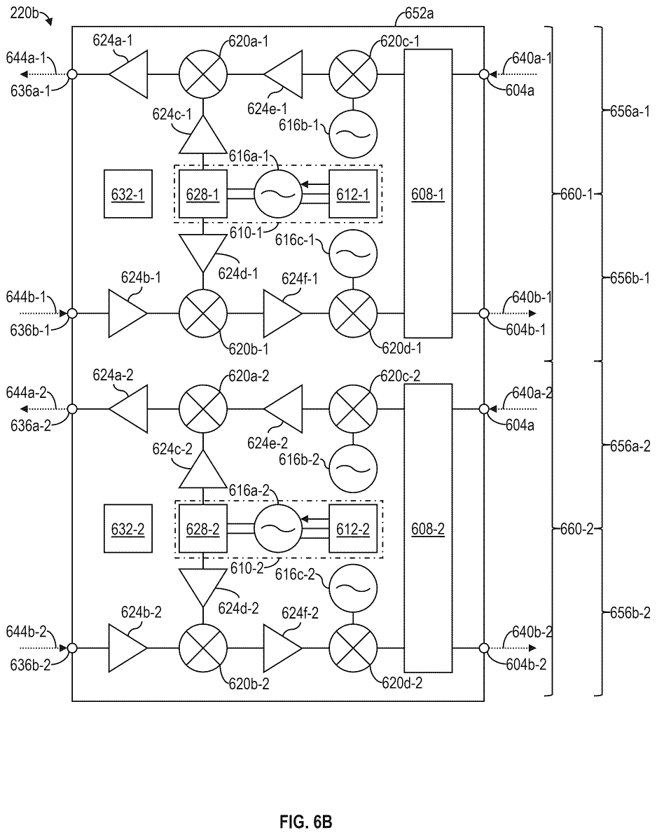

Each of the network elements 204 may comprise one or more of a fiber-coupled RF transmitter 212 (e.g., a first fiber-coupled RF transmitter 212a and a second fiber-coupled RF transmitter 212b shown in FIG. 2) operable to transmit RF signals containing encoded data via the passive waveguides 208, a fiber-coupled RF receiver 216 (e.g., a first fiber-coupled RF receiver 216a and a second fiber-coupled RF receiver 216b shown in FIG. 2) operable to receive RF signals containing encoded data via the passive waveguides 208, and/or a fiber-coupled RF transceiver 220 (e.g., a first fiber-coupled RF transceiver 220a shown in FIG. 2 and a second fiber-coupled RF transceiver 220b shown in FIG. 6B) operable to transmit and receive RF signals containing encoded data via the passive waveguides 208.

Each of the network elements 204 may further comprise a control module 224 (e.g., a first control module 224a, a second control module 224b, a third control module 224c, and a fourth control module 224d shown in FIG. 2) (collectively, the “control modules 224”) operable to regulate one or more operating parameter of the network element 204 to which the control module 224 is coupled.

In some implementations, one or more of the network elements 204 may communicate with each other via a communication network 228. The communication network 228 may permit bidirectional communication of information and/or data between one or more of the network elements 204 of the transport network 200. The communication network 228 may interface with one or more of the network elements 204 in a variety of ways. For example, in some implementations, the communication network 228 may interface by optical and/or electronic interfaces, and/or may use a plurality of network topographies and/or protocols including, but not limited to, Ethernet, TCP/IP, circuit switched path, combinations thereof, and/or the like. The communication network 228 may utilize a variety of network protocols to permit bidirectional interface and/or communication of data and/or information between one or more of the network elements 204.

The communication network 228 may be almost any type of network. For example, in some implementations, the communication network 228 may be a version of an Internet network (e.g., exist in a TCP/IP-based network). In one implementation, the communication network 228 is the Internet. It should be noted, however, that the communication network 228 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like.

If the communication network 228 is the Internet, a primary user interface of the transport network 200 may be delivered through a series of web pages or private internal web pages of a company or corporation, which may be written in hypertext markup language, JavaScript, or the like, and accessible by the user. It should be noted that the primary user interface of the transport network 200 may be another type of interface including, but not limited to, a Windows-based application, a tablet-based application, a mobile web interface, a VR-based application, an application running on a mobile device, and/or the like. In one implementation, the communication network 228 may be connected to one or more of the network elements 204.

The number of devices and/or networks illustrated in FIG. 2 is provided for exemplary purposes. In practice, there may be additional devices and/or networks, fewer devices and/or networks, different devices and/or networks, or differently arranged devices and/or networks than are shown in FIG. 2. Furthermore, two or more of the devices illustrated in FIG. 2 may be implemented within a single device, or a single device illustrated in FIG. 2 may be implemented as multiple, distributed devices. Additionally, or alternatively, one or more of the devices of the transport network 200 may perform one or more functions described as being performed by another one or more of the devices of the transport network 200.

The network elements 204a-n may take many different forms. For example, the network elements 204a-n can be integrated circuits. In this example, the network elements 204a-n (e.g., integrated circuits) would communicate via the RF signals containing encoded data via the passive waveguides 208 without requiring electrical data busses. In other implementations, the network elements 204a-n may be incorporated into components in a data center, such as servers, routers, switches, firewalls, storage systems, application delivery controllers and the like to establish communication between such components in the data center via the RF signals containing encoded data transmitted through the passive waveguides 208. The passive waveguides 208 can thus extend from one integrated circuit to another integrated circuit, or from one component to another component, and such can be implemented in a variety of ways, such as integrated circuit to integrated circuit communications, printed circuit board to printed circuit board communications, component to component communications and combinations thereof. In the example of printed circuit board to printed circuit board communications, the network elements 204a-n may each include a printed circuit board.

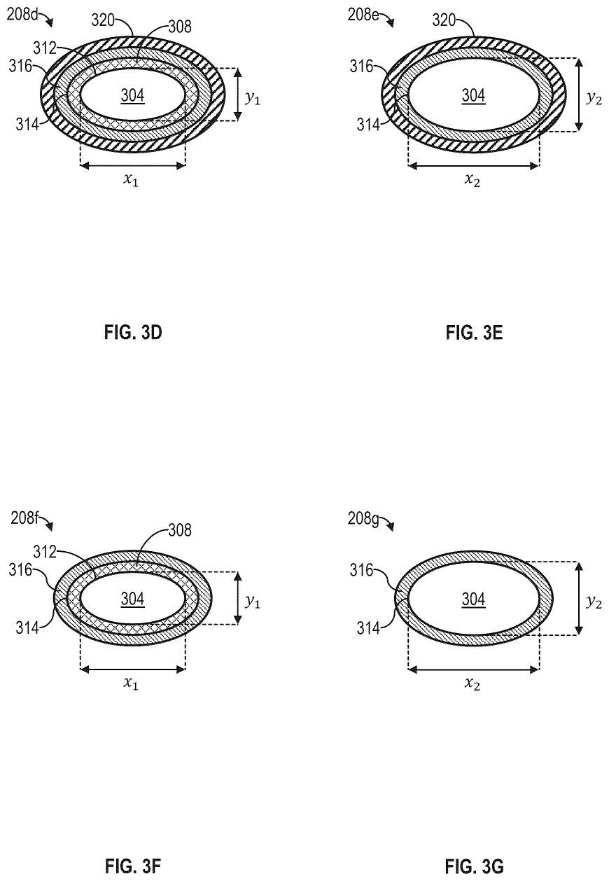

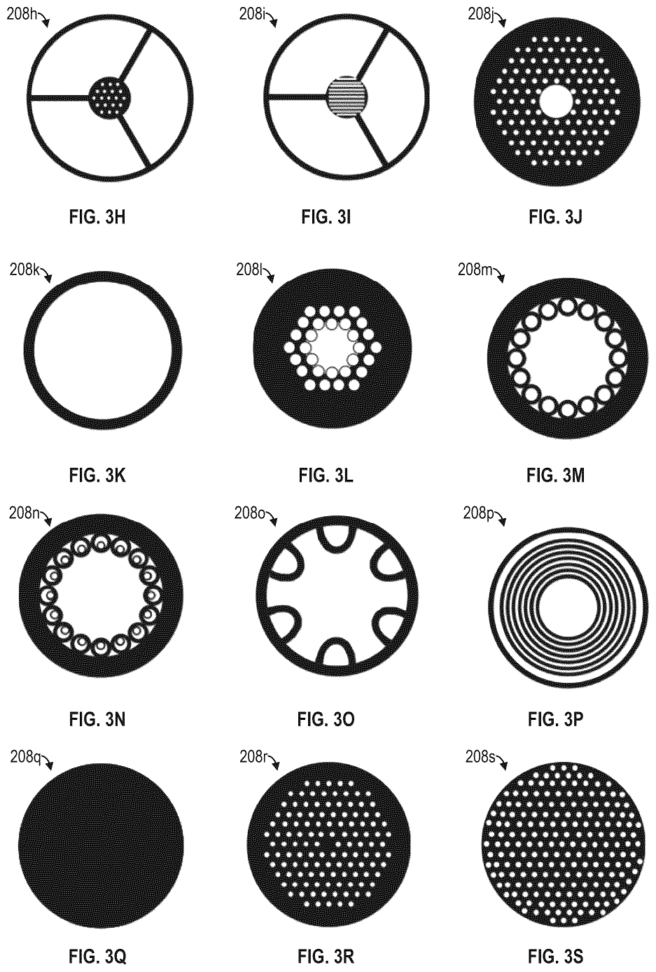

Referring now to FIG. 3A, shown therein is a cross-sectional view of an exemplary implementation of the first passive waveguide 208a shown in FIG. 2, taken along the line 1-1′ and in the direction of the arrows.

In the implementations shown in FIGS. 3A-3P, the first passive waveguide 208a is an optical fiber; however, it should be understood that in other implementations, the first passive waveguide 208a may be another form of passive waveguide, such as a routed waveguide.

In some implementations, as shown in FIG. 3A, the first passive waveguide 208a may be a single-mode fiber (i.e., operable to transmit a single mode at a given time) wherein the waveguide core 304 has a diameter d₁ that is equal along both the x-axis and the y-axis. In some such implementations, the diameter d₁ of the waveguide core 304 is between 30 μm and 3 mm. In one implementation, the diameter d₁ of the waveguide core 304 is 1 mm. However, it should be understood that, in some implementations of the transport network 200, any of the passive waveguides 208 may be implemented as a single-mode fiber. Accordingly, it should be understood that the description of the first passive waveguide 208a may be applicable to any of the passive waveguides 208.

As shown in FIG. 3A, each of the passive waveguides 208 generally comprises a waveguide core 304 operable to propagate RF signals in the THz frequency band 104, an optional dielectric layer 308 surrounding the waveguide core 304, a conductive layer 316 surrounding the optional dielectric layer 308, and a support layer 320 surrounding the conductive layer 316. In some implementations, the first passive waveguide 208a further comprises one or more strength member (not shown) surrounding the conductive layer 316 configured to enhance resilience of the first passive waveguide 208a. In such implementations, the support layer 320 surrounds the one or more strength member (not shown).

The waveguide core 304 may be composed of any material capable of propagating RF signals within the THz frequency band 104. More particularly, the waveguide core 304 is preferably composed of materials having a low absorption loss (i.e., an absorption loss in a range between 1 dB/km and 10,000 dB/km) within the THz frequency band 104, such as glass or plastic. In some implementations, the waveguide core 304 is composed of air. In such implementations, the waveguide core 304 may be defined and/or surrounded by an inner surface 312 of the optional dielectric layer 308 or an inner surface 314 of the conductive layer 316. In other implementations, the waveguide core 304 may be composed of a polymer (e.g., cyclo olefin polymer (COP), cyclic olefin co-polymer (COC), polytetrafluoroethylene (PTFE), high-density polyethylene (HDPE), polymethylpentene (PMP), polypropylene (PP), polystyrene, polycarbonate, poly(methyl methacrylate) (PMMA), Picarin, or ultraviolet (UV) resin) or glass (e.g., silica glass, crown glass, or borosilicate glass). In still other implementations, the waveguide core 304 may devoid of matter (i.e., a vacuum). As discussed in more detail below, the material composing the waveguide core 304 may have a refractive index n_{core}.

The optional dielectric layer 308 may be composed of any material having a refractive index n_{dielectric} greater than the refractive index of the waveguide core 304 (i.e., n_{core}). More particularly, the optional dielectric layer 308 is preferably composed of non-oxidizing metallic materials, such as silver, gold, or indium tin oxide (ITO), for example. Providing the optional dielectric layer 308 with a refractive index greater than the refractive index of the waveguide core 304 may cause an effective index Δn of the first passive waveguide 208a to increase, thereby causing more RF signals to be confined and propagated within the waveguide core 304.

In some implementations, the first passive waveguide 208a lacks the optional dielectric layer 308, and the conductive layer 316 surrounds the waveguide core 304. In such implementations, the conductive layer 316 may be composed of any material having a refractive index n_{conductive} greater than the refractive index of the waveguide core 304 (i.e., n_{core}), such as glass or plastic, for example. Providing the conductive layer 316 with a refractive index greater than the refractive index of the waveguide core 304 may cause an effective index Δn of the first passive waveguide 208a to increase, thereby causing more RF signals to be confined and propagated within the waveguide core 304. In implementations in which the first passive waveguide 208a includes the optional dielectric layer 308, the conductive layer 316 may be composed of glass or plastic, for example.

The support layer 320 may be configured to shield the inner layers of the first passive waveguide 208a from external environmental factors, provide flexibility to the first passive waveguide 208a, and/or enhance a tensile strength of the first passive waveguide 208a. In some implementations, the support layer 320 is composed of polymer materials, such as acrylate polymer or polyimide, for example.

Referring now to FIG. 3B, shown therein is a cross-sectional view of an exemplary implementation of the second passive waveguide 208b shown in FIG. 2, taken along the line 2-2′ and in the direction of the arrows.

In some implementations, as shown in FIG. 3B, the second passive waveguide 208b may be a multi-mode fiber (i.e., operable to transmit multiple modes at a given time) wherein the waveguide core 304 has a diameter d₂ that is greater than the diameter d₁. In some implementations the diameter d₂ is equal along both the x-axis and the y-axis. However, it should be understood that, in some implementations of the transport network 200, any of the passive waveguides 208 may be implemented as a multi-mode fiber. Accordingly, it should be understood that the description of the second passive waveguide 208b may be applicable to any of the passive waveguides 208.

Referring now to FIG. 3C, shown therein is a cross-sectional view of an exemplary implementation of the third passive waveguide 208c shown in FIG. 2, taken along the line 3-3′ and in the direction of the arrows.

In some implementations, as shown in FIG. 3C, the third passive waveguide 208c may be a photonic-bandgap fiber comprising a plurality of air channels 324 (hereinafter the “air channels 324”) periodically spaced throughout the conductive layer 316. For purposes of clarity, only one of the air channels 324 is labeled with a reference character. Further, in some implementations, the waveguide core 304 of the third passive waveguide 208c has a diameter d₃ that may be equal along both the x-axis and the y-axis. However, it should be understood that, in some implementations of the transport network 200, any of the passive waveguides 208 may be implemented as a photonic-bandgap fiber. Accordingly, it should be understood that the description of the third passive waveguide 208c may be applicable to any of the passive waveguides 208.

Referring now to FIG. 3D, shown therein is a cross-sectional view of an exemplary implementation of the fourth passive waveguide 208d shown in FIG. 2, taken along the line 4-4′ and in the direction of the arrows.

In some implementations, as shown in FIG. 3D, the fourth passive waveguide 208d may be an elliptical-core fiber wherein the waveguide core 304 has a first diameter x₁ along the x-axis and a second diameter y₁ along the y-axis, wherein the first diameter is not equal to the second diameter. However, it should be understood that, in some implementations of the transport network 200, any of the passive waveguides 208 may be implemented as an elliptical-core fiber. Accordingly, it should be understood that the description of the fourth passive waveguide 208d may be applicable to any of the passive waveguides 208.

Referring now to FIG. 3E, shown therein is a cross-sectional view of an exemplary implementation of a fifth passive waveguide 208e constructed in accordance with the present disclosure. In the implementation shown in FIG. 3E, the fifth passive waveguide 208e is an elliptical-core fiber lacking the optional dielectric layer 308 wherein the waveguide core 304 has a third diameter x₂ along the x-axis and a fourth diameter y₂ along the y-axis. As discussed above, it should be understood that the description of the fifth passive waveguide 208e may be applicable to any of the passive waveguides 208.

Referring now to FIG. 3F, shown therein is a cross-sectional view of an exemplary implementation of a sixth passive waveguide 208f constructed in accordance with the present disclosure. In the implementation shown in FIG. 3F, the sixth passive waveguide 208f is an elliptical-core fiber lacking the support layer 320. As discussed above, it should be understood that the description of the sixth passive waveguide 208f may be applicable to any of the passive waveguides 208.

Referring now to FIG. 3G, shown therein is a cross-sectional view of an exemplary implementation of a seventh passive waveguide 208g constructed in accordance with the present disclosure. In the implementation shown in FIG. 3G, the seventh passive waveguide 208g is an elliptical-core fiber lacking the optional dielectric layer 308 and the support layer 320. As discussed above, it should be understood that the description of the seventh passive waveguide 208g may be applicable to any of the passive waveguides 208.

Referring now to FIGS. 3H-3S, shown therein are cross-sectional views of other exemplary implementations of the passive waveguides 208 shown in FIG. 2. As shown in FIGS. 3H-3S, other implementations of the first passive waveguide 208a include implementation as a suspended porous-core fiber 208h (shown in FIG. 3H), a suspended slotted core fiber 208i (shown in FIG. 3I), a hollow-core bandgap fiber 208j (shown in FIG. 3J), a hollow-core tube fiber 208k (shown in FIG. 3K), a hollow-core fiber with negative curvature 208l (shown in FIG. 3L), a hollow-core fiber based on anti-resonances and inhibited coupling 208m (shown in FIG. 3M), a hollow-core nested anti-resonant nodeless fiber 208n (shown in FIG. 3N), a 3D-printed hollow-core fiber based on anti-resonances and inhibited coupling 208o (shown in FIG. 3O), a Bragg fiber 208p (shown in FIG. 3P), a solid rod fiber 208q (shown in FIG. 3Q), a microstructured optical fiber 208r (shown in FIG. 3R), or a porous fiber 208s (shown in FIG. 3S). As discussed above, it should be understood that the description of the passive waveguides 208h-208s may be applicable to any of the passive waveguides 208.

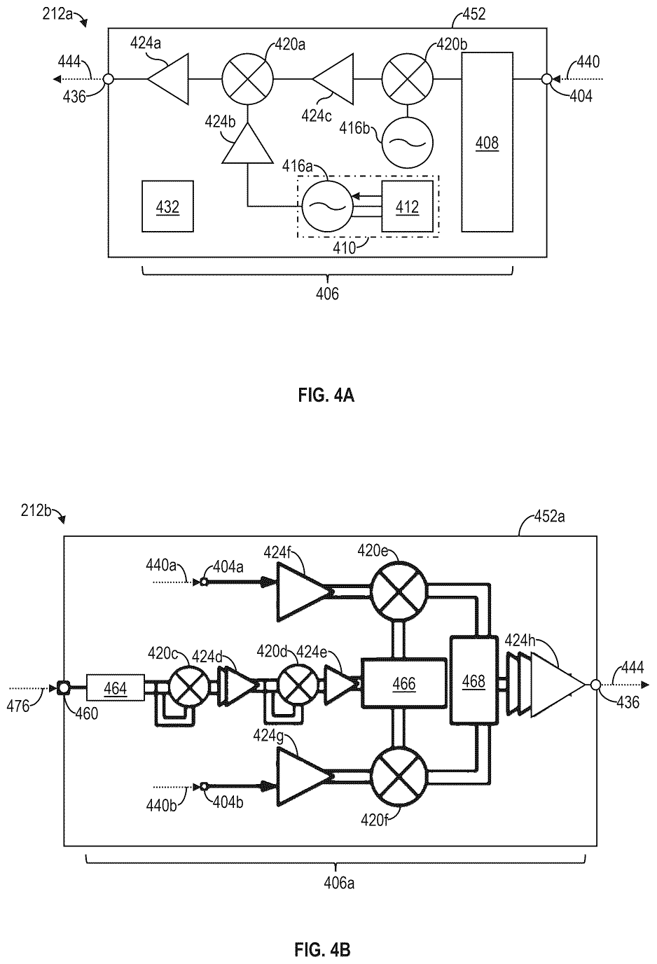

Referring now to FIG. 4A, shown therein is a block diagram of an exemplary implementation of the first fiber-coupled RF transmitter 212a (hereinafter the “first transmitter 212a”) shown in FIG. 2.

The first fiber-coupled RF transmitter 212a generally comprises an input interface 404 configured to receive input signals 440 from one or more external component (e.g., a control module 224 of a network element 204), circuitry 406 configured to generate signals 444 (hereinafter the “transmission signals 444”) based on the input signals 440, an RF interface 436 configured to transmit the transmission signals 444, and a digital enhancement and control unit 432. In some implementations, the input signals 440 are digital bitstreams.

In the implementation shown, the circuitry 406 comprises one or more modulation block 408 (hereinafter the “modulation block 408”), a frequency synthesizer 410 comprising a phase-locked loop (PLL) 412 and a first local oscillator (LO) 416a, a second LO 416b, one or more frequency mixer (e.g., a first frequency mixer 420a and a second frequency mixer 420b shown in FIG. 4A), and one or more amplifier (e.g., a first amplifier 424a, a second amplifier 424b, and a third amplifier 424c shown in FIG. 4A).

In some implementations, the input interface 404 is a pair of input interfaces to receive a differential signal. In some such implementations, the input interface 404 is a low voltage differential signaling (LVDS) link configured to receive LVDS signals, and the input signals 440 are LVDS signals indicative of data. In some implementations, the input signals 440 are indicative of data encoded in a NRZ, NRZI, PAM, or PAM4 format. The input interface 404 may be further configured to send the input signals 440 to the modulation block 408.

The modulation block 408 may be configured to receive the input signals 440 from the input interface 404 and encode the input signals 440 in a format suitable for modulation onto a carrier signal.

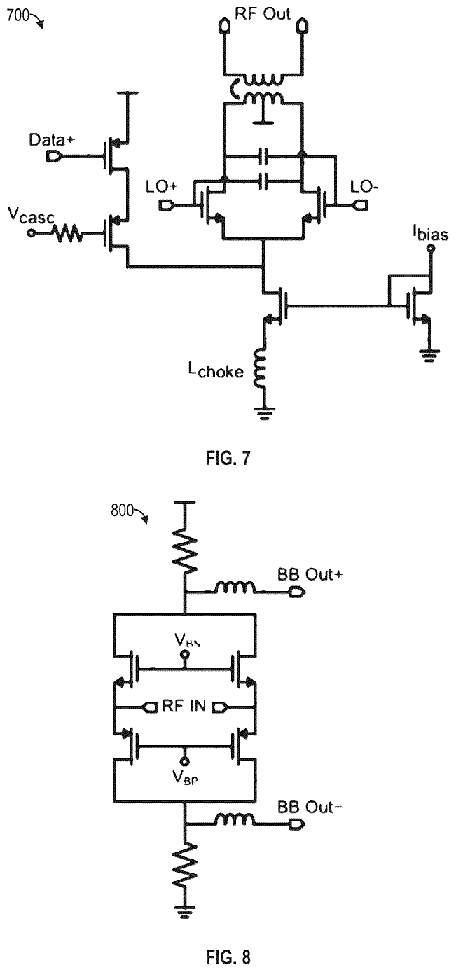

In some implementations, the modulation block 408 may include one or more digital-to-analog converter (DAC), one or more Serializer/Deserializer (SerDes), one or more folded modulator 700 (shown in FIG. 7), and/or circuitry operable to encode the input signals 440 in a modulation format, such as AM, ASK, PSK, QAM, QAM16, or variations thereof, for example. In some implementations, the modulation block 408 may include circuitry operable to perform forward error correction (FEC). The modulation block 408 may be further configured to send the encoded input signals having the data encoded therein to the second frequency mixer 420b.

In some implementations, the modulation block 408 is configured to simply receive the input signals 440 (i.e., the input signals 440 having been previously encoded in a modulation format) from the input interface 404 and send the input signals 440 to the second frequency mixer 420b.

The second LO 416b may be configured to generate baseband signals having a continuous waveform (e.g., a sinusoidal waveform) having a predetermined frequency (i.e., a baseband (BB) frequency). In some implementations, the predetermined frequency of the baseband signals (i.e., the BB frequency) is in an RF band (i.e., in a range between 30 Hertz (Hz) and 300 GHz). In some implementations, the predetermined frequency of the baseband signals (i.e., the BB frequency) is in a range between 1 Megahertz (MHz) and 300 GHz. In some implementations, the predetermined frequency of the baseband signals (i.e., the BB frequency) is in a range between 5 GHz and 30 GHz. The second LO 416b may be further configured to send the baseband signals to the second frequency mixer 420b.

The second frequency mixer 420b may be configured to receive the encoded input signals from the modulation block 408, receive the baseband signals from the second LO 416b, up-convert the encoded input signals with the baseband signals to produce first modulated signals having the data encoded therein and having the predetermined frequency of the baseband signals (i.e., the BB frequency), and send the first modulated signals to the third amplifier 424c.

The third amplifier 424c may be configured to receive the first modulated signals from the second frequency mixer 420b, adjust an amplitude of the first modulated signals such that the amplified first modulated signals can drive the first frequency mixer 420a, and send the amplified first modulated signals to the first frequency mixer 420a.

The frequency synthesizer 410 may be configured to generate carrier signals having a continuous waveform (e.g., a sinusoidal waveform) having a predetermined frequency (e.g., within the THz frequency band 104). In some implementations, the predetermined frequency of the carrier signals is in a range between 30 GHz and 300 GHz. In some such implementations, the predetermined frequency of the carrier signals is 240 GHz. In other implementations, the predetermined frequency of the carrier signals is in a range between 300 GHz and 10 THz. The frequency synthesizer 410 may be further configured to send the carrier signals to the second amplifier 424b.

The second amplifier 424b may be configured to receive the carrier signals from the first LO 416a, adjust an amplitude of the carrier signals such that the amplified carrier signals can drive the first frequency mixer 420a, and send the amplified carrier signals to the first frequency mixer 420a.

The first frequency mixer 420a may be configured to receive the amplified carrier signals from the second amplifier 424b, receive the amplified first modulated signals from the third amplifier 424c, up-convert the amplified first modulated signals with the amplified carrier signals to produce second modulated signals having the data encoded therein and having the predetermined frequency of the amplified carrier signals (e.g., within the THz frequency band 104), and send the second modulated signals to the first amplifier 424a.

The first amplifier 424a may be configured to receive the second modulated signals from the first frequency mixer 420a, adjust an amplitude of the second modulated signals such that the amplified second modulated signals can be transmitted by the RF interface 436, and send the amplified second modulated signals to the RF interface 436. The first amplifier 424a may be configured to generate the amplified second modulated signals to have a power in a range between 0.05 Watts and 0.4 Watts, for example.

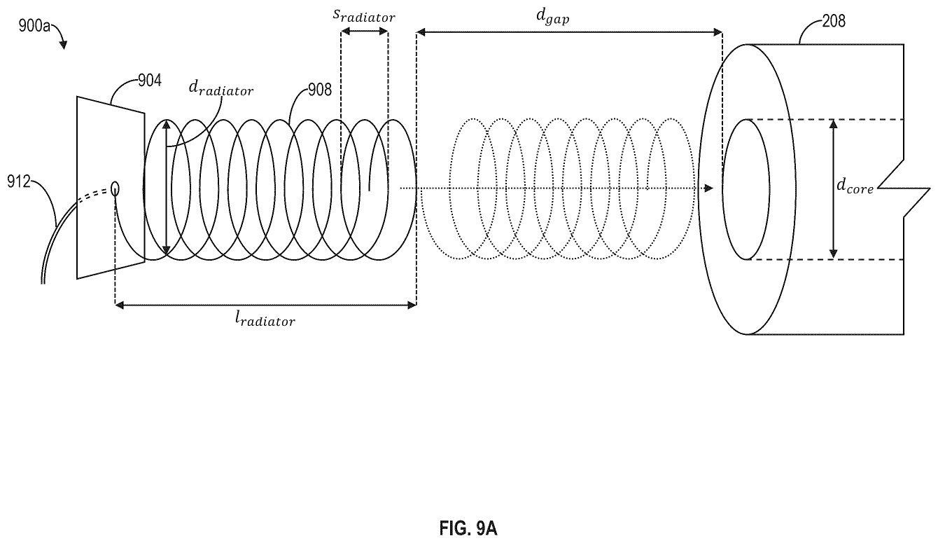

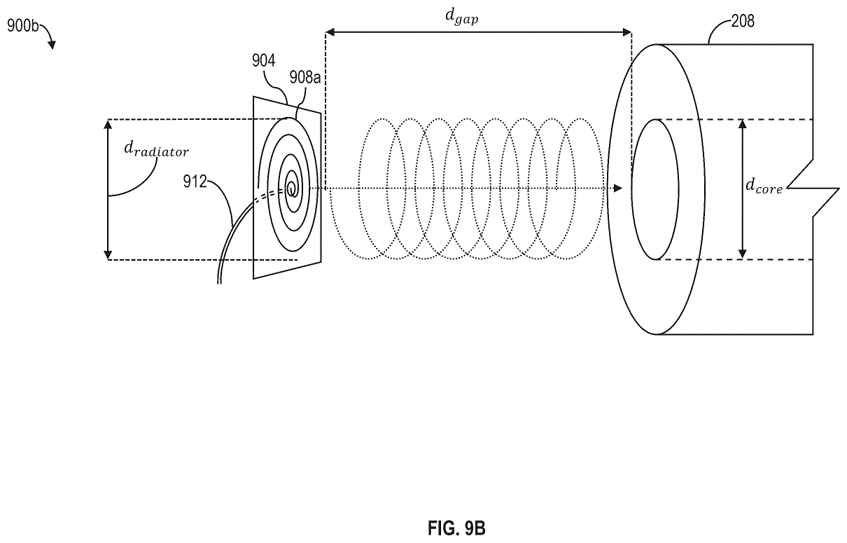

The RF interface 436 may be configured to receive the amplified second modulated signals indicative of data from the first amplifier 424a and send the amplified second modulated signals as transmission signals 444 (i.e., having the data encoded therein) within a predetermined frequency range (e.g., the THz frequency band 104t, the RF interface 436 may be electrically connected to an RF antenna 900 (shown in FIGS. 9A-9B, 10A-10J, 11, and 12A-12B) and configured to send the transmission signals 444 to the RF antenna 900. In other implementations, however, the RF antenna 900 may be included in place of the RF interface 436, or the RF antenna 900 may be a part of the RF interface 436. The RF antenna 900 converts the transmission signals 444 into an electromagnetic wave in the THz frequency band 104 to be coupled into the passive waveguide 208.

In some implementations, as shown in FIG. 4A, each of the components of the first fiber-coupled RF transmitter 212a are disposed on a single substrate 452, which may be a portion of a semiconductor wafer. In some implementations, one or more, or all of the components of the first fiber-coupled RF transmitter 212a are implemented using complementary metal-oxide semiconductor (CMOS) technology.

The digital enhancement and control unit 432 may be configured to provide digital control and/or processing capabilities for one or more of the components of the first fiber-coupled RF transmitter 212a.

Referring now to FIG. 4B, shown therein is a block diagram of an exemplary implementation of the second fiber-coupled RF transmitter 212b (hereinafter the “second transmitter 212b”) shown in FIG. 2. In the implementation shown, the second fiber-coupled RF transmitter 212b may be based upon an implementation of QAM or QAM16 modulation.

The second fiber-coupled RF transmitter 212b generally comprises one or more input interface (e.g., an in-phase (I)-BB input interface 404a, a quadrature (Q)-BB input interface 404b, and an LO input interface 460) configured to receive input signals (e.g., I-BB input signals 440a, Q-BB input signals 440b, and carrier signals 476) from one or more external component (e.g., a control module 224 of a network element 204 or an external LO), circuitry 406a configured to generate the transmission signals 444 based on the input signals (e.g., I-BB input signals 440a, Q-BB input signals 440b, and carrier signals 476), and the RF interface 436 configured to supply the transmission signals 444 to be subsequently transmitted the transmission signals 444.

In the implementation shown, the circuitry 406a comprises a balancing unit (Balun) 464, one or more frequency mixer (e.g., a third frequency mixer 420c, a fourth frequency mixer 420d, a fifth frequency mixer 420e, and a sixth frequency mixer 420f shown in FIG. 4B), one or more amplifier (e.g., a fourth amplifier 424d, a fifth amplifier 424e, a sixth amplifier 424f, a seventh amplifier 424g, and an eighth amplifier 424h shown in FIG. 4B), a quadrature coupler (e.g., branchline coupler) 466, and a power combiner (e.g., Wilkinson power combiner) 468.

In some implementations, as shown in FIG. 4B, each of the components of the second fiber-coupled RF transmitter 212b are disposed on a single substrate 452a, which may be a portion of a semiconductor wafer. In some implementations, one or more, or all of the components of the second fiber-coupled RF transmitter 212b are implemented using complementary metal-oxide semiconductor (CMOS) technology.

The I-BB input signals 440a and the Q-BB input signals 440b may be I and Q components of data signals indicative of data. The I-BB input interface 404amay be configured to send the I-BB input signals 440a to the sixth amplifier 424f. The Q-BB input interface 404b may be configured to send the Q-BB input signals 440b to the seventh amplifier 424g.

The LO input interface 460 may be configured to receive the carrier signals 476 from an external LO, the carrier signals 476 having a continuous waveform (e.g., a sinusoidal waveform) having a predetermined frequency. The LO input interface 460 may be further configured to send the carrier signals 476 to the Balun 464.

The Balun 464 may be configured to isolate and/or maintain impedance differences between balanced transmission lines and unbalanced transmission lines. The Balun 464 may be further configured to send the carrier signals 476 to the third frequency mixer 420c.

The third frequency mixer 420c may be configured to receive the carrier signals 476 from the Balun 464, multiply the carrier signals 476 (e.g., by a multiple of four), and send the multiplied carrier signals to the fourth amplifier 424d.

The fourth amplifier 424d may be configured to receive the carrier signals 476 from the third frequency mixer 420c, adjust an amplitude of the multiplied carrier signals such that the amplified carrier signals can drive the fourth frequency mixer 420d, and send the amplified carrier signals to the fourth frequency mixer 420d.

The fourth frequency mixer 420d may be configured to receive the amplified carrier signals from the fourth amplifier 424d, multiply the amplified carrier signals (e.g., by a multiple of two), and send the remultiplied carrier signals to the fifth amplifier 424e.

The fifth amplifier 424e may be configured to receive the remultiplied carrier signals from the fourth frequency mixer 420d, adjust an amplitude of the remultiplied carrier signals such that the reamplified carrier signals can drive the quadrature coupler (e.g., branchline coupler) 466, and send the reamplified carrier signals to the quadrature coupler (e.g., branchline coupler) 466.

The sixth amplifier 424f may be configured to receive the I-BB input signals 440a from the I-BB input interface 404a, adjust an amplitude of the I-BB input signals 440a such that the amplified I-BB input signals can drive the fifth frequency mixer 420e, and send the amplified I-BB signals to the fifth frequency mixer 420e.

The seventh amplifier 424g may be configured to receive the Q-BB input signals 440b from the Q-BB input interface 404b, adjust an amplitude of the Q-BB input signals 440b such that the amplified Q-BB input signals 440b can drive the sixth frequency mixer 420f, and the amplified Q-BB signals to the sixth frequency mixer 420f.

The quadrature coupler (e.g., branchline coupler) 466 may be configured to receive the reamplified carrier signals from the fifth amplifier 424e, split the reamplified carrier signals into first carrier signals and second carrier signals, send the first carrier signals to the fifth frequency mixer 420e, and send the second carrier signals to the sixth frequency mixer 420f, wherein the first carrier signals and the second carrier signals are out of phase by 90°.

The fifth frequency mixer 420e may be configured to receive the amplified I-BB signals from the sixth amplifier 424f, receive the first carrier signals from the quadrature coupler (e.g., branchline coupler) 466, up-convert the amplified I-BB signals with the first carrier signals to produce I-transmission signals having the I component of the data encoded therein and having the predetermined frequency of the carrier signals 476, and send the I-transmission signals to the power combiner (e.g., Wilkinson power combiner) 468.

The sixth frequency mixer 420f may be configured to receive the amplified Q-BB signals from the seventh amplifier 424g, receive the second carrier signals from the quadrature coupler (e.g., branchline coupler) 466, up-convert the amplified Q-BB signals with the second carrier signals to produce Q-transmission signals having the Q component of the data encoded therein and having the predetermined frequency of the carrier signals 476, and send the Q-transmission signals to the power combiner (e.g., Wilkinson power combiner) 468.

The power combiner (e.g., Wilkinson power combiner) 468 may be configured to receive the I-transmission signals from the fifth frequency mixer 420e, receive the Q-transmission signals from the sixth frequency mixer 420f, combine the I-transmission signals and the Q-transmission signals to produce the transmission signals 444, and send the transmission signals 444 to the eighth amplifier 424h, which may send the transmission signals 444 to the RF interface 436. In some implementations, the RF interface 436 may be electrically connected to the RF antenna 900 (shown in FIGS. 9A-9B, 10A-10J, 11, and 12A-12B) and configured to send the transmission signals 444 to the RF antenna 900. In other implementations, however, the RF antenna 900 may be included in place of the RF interface 436, or the RF antenna 900 may be a part of the RF interface 436. The RF antenna 900 converts the transmission signals 444 into electromagnetic waves in the THz frequency band 104 to be coupled into the passive waveguide 208.

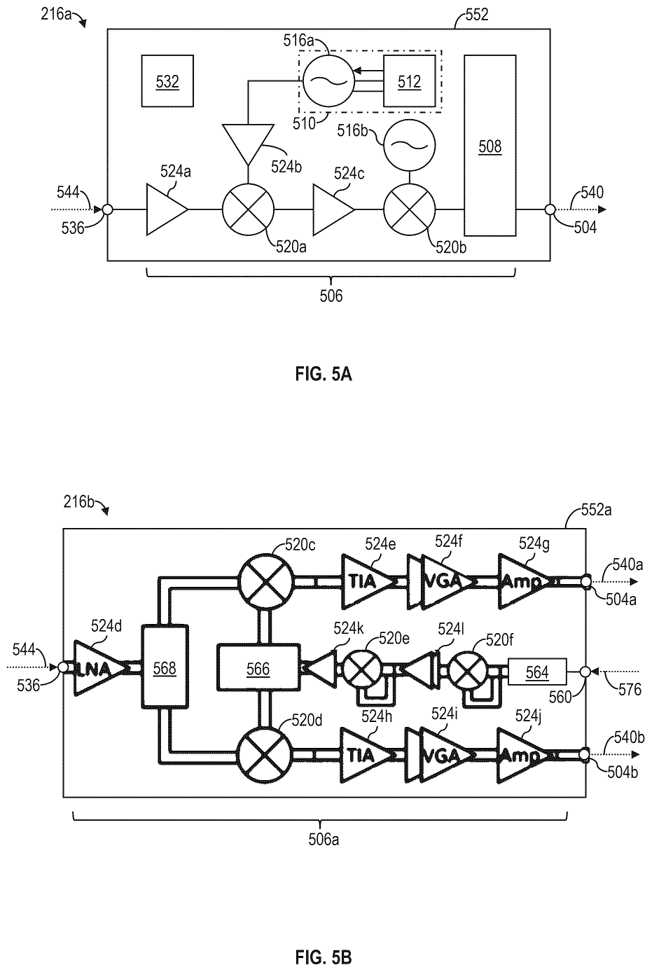

Referring now to FIG. 5A, shown therein is a block diagram of an exemplary implementation of the first fiber-coupled RF receiver 216a (hereinafter the “first receiver 216a”) shown in FIG. 2.

The first fiber-coupled RF receiver 216a generally comprises an RF interface 536 configured to receive transmission signals 544 (hereinafter the “transmission signals 544”), circuitry 506 configured to generate output signals 540 based on the transmission signals 544, an output interface 504 configured to transmit the output signals 540 to one or more external component (e.g., a control module 224 of a network element 204), and a digital enhancement and control unit 532. In some implementations, the output signals 540 are digital bitstreams.

In the implementation shown, the circuitry 506 comprises one or more modulation block 508 (hereinafter the “modulation block 508”), a frequency synthesizer 510 comprising a PLL 512 and a first LO 516a, a second LO 516b, one or more frequency mixer (e.g., a first frequency mixer 520a and a second frequency mixer 520b shown in FIG. 5A), one or more amplifier (e.g., a first amplifier 524a, a second amplifier 524b, and a third amplifier 524c shown in FIG. 5A).

In some implementations, as shown in FIG. 5A, each of the components of first fiber-coupled RF receiver 216a are disposed on a single substrate 552, which may be a portion of a semiconductor wafer. In some implementations, one or more, or all of the components of the first fiber-coupled RF receiver 216a are implemented using complementary metal-oxide semiconductor (CMOS) technology.

The transmission signals 544 (i.e., having data encoded therein) may have a frequency within a predetermined frequency range (e.g., the THz frequency band 104). The RF interface 536 may be configured to send the transmission signals 544 to the first amplifier 524a. In some implementations, the RF interface 536 may be configured to receive the transmission signals 544 from an RF antenna 900 (shown in FIGS. 9A-9B, 10A-10J, 11, and 12A-12B). In other implementations, the RF antenna 900 may be included in place of the RF interface 536, or the RF antenna 900 may be a part of the RF interface 536.

The first amplifier 524a may be configured to receive the transmission signals 544 from the RF interface 536, adjust an amplitude of the transmission signals 544 such that the amplified transmission signals can drive the first frequency mixer 520a, and send the amplified transmission signals to the first frequency mixer 520a.

The frequency synthesizer 510 may be configured to generate carrier signals having a continuous waveform (e.g., a sinusoidal waveform) having a predetermined frequency (e.g., within the THz frequency band 104). In some implementations, the predetermined frequency of the carrier signals is in a range between 30 GHz and 300 GHz. In some such implementations, the predetermined frequency of the carrier signals is 240 GHz. In other implementations, the predetermined frequency of the carrier signals is in a range between 300 GHz and 10 THz. The first LO 516a may be further configured to send the carrier signals to the second amplifier 524b.

The second amplifier 524b may be configured to receive the carrier signals from the first LO 516a, adjust an amplitude of the carrier signals such that the amplified carrier signals can drive the first frequency mixer 520a, and send the amplified carrier signals to the first frequency mixer 520a.

The first frequency mixer 520a may be configured to receive the transmission signals 544 from the first amplifier 524a, receive the amplified carrier signals from the second amplifier 524b, down-convert the transmission signals 544 with the amplified carrier signals to produce modulated signals having the data encoded therein and having the BB frequency, and send the modulated signals to the third amplifier 524c.

The third amplifier 524c may be configured to receive the modulated signals from the first frequency mixer 520a, adjust an amplitude of the modulated signals such that the amplified modulated signals can drive the second frequency mixer 520b, and send the amplified modulated signals to the second frequency mixer 520b.

The second LO 516b may be configured to generate baseband signals having a continuous waveform (e.g., a sinusoidal waveform) having a predetermined frequency (i.e., the BB frequency). In some implementations, the predetermined frequency of the second LO signals (i.e., the BB frequency) is in a range between 8 GHz and 10 GHz. The second LO 516b may be further configured to send the baseband signals to the second frequency mixer 520b.

The second frequency mixer 520b may be configured to receive the amplified modulated signals from the third amplifier 524c, receive the baseband signals from the second LO 516b, down-convert the amplified modulated signals with the baseband signals to produce encoded signals having the data encoded therein and having the predetermined frequency of the baseband signals (i.e., the BB frequency), and send the encoded signals to the modulation block 508.

The modulation block 508 may be configured to receive the encoded signals from the second frequency mixer 520b and decode the encoded signals in a format suitable for transmission to one or more external component (e.g., a control module 224 of a network element 204) to generate the output signals 540.

In some implementations, the modulation block 508 may include one or more analog-to-digital converter (ADC), one or more Serializer/Deserializer (SerDes), one or more rectifying detector 800 (shown in FIG. 8), and/or circuitry operable to decode the encoded output signals from a modulation format, such as AM, ASK, PSK, QAM, or QAM16, or variations thereof, for example, to produce output signals 540 indicative of data. In some implementations, the modulation block 508 may include circuitry operable to perform forward error correction (FEC). The modulation block 508 may be further configured to send the output signals 540 to the output interface 504. In some implementations, the modulation block 508 is configured to simply receive the encoded signals from the second frequency mixer 520b and send the encoded signals as the output signals 540 to the output interface 504.

In some implementations, the output interface 504 is a pair of output interfaces. In some such implementations, the output interface 504 is a LVDS link configured to transmit LVDS signals, and the output signals 540 are LVDS signals indicative of data. In some implementations, the output signals 540 are encoded in a NRZ, NRZI, PAM, or PAM4 format.

The digital enhancement and control unit 532 may be configured to provide digital control and/or processing capabilities for one or more of the components of the first fiber-coupled RF receiver 216a.

Referring now to FIG. 5B, shown therein is a block diagram of an exemplary implementation of the second fiber-coupled RF receiver 216b (hereinafter the “second receiver 216b”) shown in FIG. 2. In the implementation shown, the second fiber-coupled RF receiver 216b may be based upon an implementation of QAM or QAM16 modulation.

The second fiber-coupled RF receiver 216b generally comprises the RF interface 536 configured to receive the transmission signals 544, an LO input interface 560 configured to receive carrier signals 576 from an external LO, circuitry 506a configured to generate the output signals (i.e., the Q-BB output signals 540a and the I-BB output signals 540b) based on the input signals (i.e., the transmission signals 544 and the carrier signals 576), and one or more output interface (e.g., a Q-BB output interface 504a and an I-BB output interface 504b) configured to transmit the Q-BB output signals 540a and the I-BB output signals 540b.

In the implementation shown, the circuitry 506a comprises one or more frequency mixer (e.g., a third frequency mixer 520c, a fourth frequency mixer 520d, a fifth frequency mixer 520e, and a sixth frequency mixer 520f shown in FIG. 5B), one or more amplifier (e.g., a fourth amplifier 524d, a fifth amplifier 524e, a sixth amplifier 524f, a seventh amplifier 524g, an eighth amplifier 524h, a ninth amplifier 524i, a tenth amplifier 524j, an eleventh amplifier 524k, and a twelfth amplifier 524l shown in FIG. 5B), a Balun 564, a quadrature coupler (e.g., branchline coupler) 566, and a power divider (e.g., Wilkinson power divider) 568.

In some implementations, as shown in FIG. 5B, each of the components of the second fiber-coupled RF receiver 216b are disposed on a single substrate 552a, which may be a portion of a semiconductor wafer. In some implementations, one or more, or all of the components of the second fiber-coupled RF receiver 216b are implemented using complementary metal-oxide semiconductor (CMOS) technology.

The fourth amplifier 524d may be configured to receive the transmission signals 544 from the RF interface 536, adjust an amplitude of the transmission signals 544 such that the amplified transmission signals can drive the power divider (e.g., Wilkinson power divider) 568, and send the amplified transmission signals to the power divider (e.g., Wilkinson power divider) 568. In some implementations, the fourth amplifier 524d is a low-noise amplifier (LNA).

The power divider (e.g., Wilkinson power divider) 568 may be configured to receive the amplified transmission signals from the fourth amplifier 524d, split the amplified transmission signals into I-transmission signals having the I component of the data encoded therein and Q-transmission signals having the Q component of the data encoded therein, send the Q-transmission signals to the third frequency mixer 520c, and send the I-transmission signals to the fourth frequency mixer 520d.

The LO input interface 560 may be configured to receive carrier signals 576 from an external LO, the carrier signals 576 having a continuous waveform (e.g., a sinusoidal waveform) having a predetermined frequency. The LO input interface 560 may be further configured to send the carrier signals 576 to the Balun 564.

The Balun 564 may be configured to isolate and/or maintain impedance differences between balanced transmission lines and unbalanced transmission lines. The Balun 564 may be further configured to send the carrier signals 576 to the sixth frequency mixer 520f.

The sixth frequency mixer 520f may be configured to receive the carrier signals 576 from the Balun 564, multiply the carrier signals 576 (e.g., by a multiple of four), and send the multiplied carrier signals to the twelfth amplifier 524l.

The twelfth amplifier 524l may be configured receive the multiplied carrier signals from the sixth frequency mixer 520f, adjust an amplitude of the multiplied carrier signals such that the amplified carrier signals can drive the fifth frequency mixer 520e, and send the amplified carrier signals to the fifth frequency mixer 520e.

The fifth frequency mixer 520e may be configured to receive the amplified carrier signals from the twelfth amplifier 524l, multiply the amplified carrier signals (e.g., by a multiple of two), and send the remultiplied carrier signals to the eleventh amplifier 524k.

The eleventh amplifier 524k may be configured to receive the remultiplied carrier signals from the fifth frequency mixer 520e, adjust an amplitude of the remultiplied carrier signals such that the reamplified carrier signals can drive the quadrature coupler (e.g., branchline coupler) 566, and send the reamplified carrier signals to the quadrature coupler (e.g., branchline coupler) 566.

The quadrature coupler (e.g., branchline coupler) 566 may be configured to receive the reamplified carrier signals from the eleventh amplifier 524k, split the reamplified carrier signals into first carrier signals and second carrier signals, send the first carrier signals to the third frequency mixer 520c, and send the second carrier signals to the fourth frequency mixer 520d, wherein the first carrier signals and the second carrier signals are out of phase by 90°.

The third frequency mixer 520c may be configured to receive the Q-transmission signals from the power divider (e.g., Wilkinson power divider) 568, receive the first carrier signals from the quadrature coupler (e.g., branchline coupler) 566, down-convert the Q-transmission signals with the first carrier signals to generate Q-BB intermediate signals having the Q component of the data encoded therein and having the BB frequency, and send the Q-BB intermediate signals to the fifth amplifier 524e.

The fifth amplifier 524e, the sixth amplifier 524f, and the seventh amplifier 524g may be configured to receive the Q-BB intermediate signals from the third frequency mixer 520c, down-convert the Q-BB intermediate signals to generate the Q-BB output signals 540a, and send the Q-BB output signals 540a to the Q-BB output interface 504a. In some implementations, the fifth amplifier 524e is a transimpedance amplifier (TIA), and the sixth amplifier 524f is a variable-gain amplifier (VGA).

The fourth frequency mixer 520d may be configured to receive the I-transmission signals from the power divider (e.g., Wilkinson power divider) 568, receive the second carrier signals from the quadrature coupler (e.g., branchline coupler) 566, down-convert the I-transmission signals with the second carrier signals to produce I-BB intermediate signals having the I component of the data encoded therein and having the BB frequency, and send the I-BB intermediate signals to the eighth amplifier 524h.

The eighth amplifier 524h, the ninth amplifier 524i, and the tenth amplifier 524j may be configured to receive the I-BB intermediate signals from the fourth frequency mixer 520d, down-convert the I-BB intermediate signals to generate the I-BB output signals 540b, and send the I-BB output signals 540b to the I-BB output interface 504b. In some implementations, the eighth amplifier 524h is a TIA, and the ninth amplifier 524i is VGA.

Referring now to FIG. 6A, shown therein is a block diagram of an exemplary implementation of the first fiber-coupled RF transceiver 220a (hereinafter the “first transceiver 220a”) shown in FIG. 2.

The first fiber-coupled RF transceiver 220a generally comprises an input interface 604a configured to receive input signals 640a from one or more external component (e.g., a control module 224 of a network element 204), first circuitry 656a (hereinafter the “Tx circuitry 656a”) configured to generate first transmission signals 644a based on the input signals 640a, a first RF interface 636a configured to transmit the first transmission signals 644a, a second RF interface 636b configured to receive second transmission signals 644b, second circuitry 656b (hereinafter the “Rx circuitry 656b”) configured to generate output signals 640b based on the second transmission signals 644b, an output interface 604b configured to transmit the output signals 640b to one or more external component, and a digital enhancement and control unit 632. In some implementations, the input signals 640a and the output signals 640b are digital bitstreams.

In some implementations, the first fiber-coupled RF transceiver 220a comprises the first RF interface 636a, but lacks the second RF interface 636b. In such implementations, the first RF interface 636a may be configured to transmit first transmission signals 644a and receive second transmission signals 644b. In some such implementations, the first transmission signals 644a and the second transmission signals 644b may have differences in frequency, polarization, etc. In other implementations, the first fiber-coupled RF transceiver 220a may have a number of RF interfaces that is greater than two.

In the implementation shown, the Tx circuitry 656a comprises a frequency synthesizer 610 comprising a PLL 612, a first LO 616a, and a signal distribution block (e.g., splitter) 628, one or more modulation block 608 (hereinafter the “modulation block 608”), a second LO 616b, a first frequency mixer 620a, a third frequency mixer 620c, a first amplifier 624a, a third amplifier 624c, and a fifth amplifier 624e.

In the implementation shown, the Rx circuitry 656b comprises the frequency synthesizer 610 comprising the PLL 612, the first LO 616a, and the signal distribution block (e.g., splitter) 628, the modulation block 608, a third LO 616c, a second frequency mixer 620b, a fourth frequency mixer 620d, a second amplifier 624b, a fourth amplifier 624d, and a sixth amplifier 624f.

In some implementations, as shown in FIG. 6A, each of the components of the first fiber-coupled RF transceiver 220a are disposed on a single substrate 652, which may be a portion of a semiconductor wafer. In some implementations, one or more, or all of the components of the first fiber-coupled RF transceiver 220a are implemented using complementary metal-oxide semiconductor (CMOS) technology.

The modulation block 608 may be configured to: (1) receive the input signals 640a from the input interface 604a, encode the input signals 640a in a format suitable for modulation onto a carrier signal, and send the encoded input signals to the third frequency mixer 620c; and (2) receive the encoded output signals from the fourth frequency mixer 620d, decode the encoded output signals in a format suitable for transmission to one or more external component (e.g., a control module 224 of a network element 204), and send the output signals 640b to the output interface 604b.

In some implementations, the modulation block 608 may include one or more DAC, one or more ADC, one or more Serializer/Deserializer (SerDes), one or more folded modulator 700 (shown in FIG. 7), one or more rectifying detector 800 (shown in FIG. 8) and/or circuitry operable to encode the input signals 640a in a modulation format, such as AM, ASK, PSK, QAM, or QAM16, or variations thereof, for example, and decode encoded output signals from the modulation format to produce output signals 640b indicative of data. In some implementations, the modulation block 408 may include circuitry operable to perform forward error correction (FEC).

The frequency synthesizer 610 may be configured to generate carrier signals having a continuous waveform (e.g., a sinusoidal waveform) having a predetermined frequency (e.g., within the THz frequency band 104). In some implementations, the predetermined frequency of the carrier signals is in a range between 30 GHz and 300 GHz. In some such implementations, the predetermined frequency of the carrier signals is 240 GHz. In other implementations, the predetermined frequency of the carrier signals is in a range between 300 GHz and 10 THz. The frequency synthesizer 610 may be further configured to send the carrier signals to the signal distribution block (e.g., splitter) 628.

The signal distribution block (e.g., splitter) 628 may be configured to receive the carrier signals from the first LO 616a and distribute the carrier signals to the third amplifier 624c and the fourth amplifier 624d.

Referring now to the Tx circuitry 656a, in some implementations, the input interface 604a is a pair of input interfaces. In some such implementations, the input interface 604a is a LVDS link configured to receive LVDS signals, and the input signals 640a are LVDS signals indicative of data. In some implementations, the input signals 640a are indicative of data encoded in a NRZ, NRZI, PAM, or PAM4 format. The input interface 604a may be further configured to send the input signals 640a to the modulation block 608.

The second LO 616b may be configured to generate first baseband signals having a continuous waveform (e.g., a sinusoidal waveform) having a predetermined frequency (i.e., the BB frequency). In some implementations, the predetermined frequency of the first baseband signals (i.e., the BB frequency) is in a range between 8 GHz and 10 GHz. The second LO 616b may be further configured to send the first baseband signals to the third frequency mixer 620c.

The third frequency mixer 620c may be configured to receive the encoded input signals from the modulation block 608, receive the first baseband signals from the second LO 616b, up-convert the encoded input signals with the first baseband signals to produce first modulated signals having the data encoded therein and having the predetermined frequency of the first baseband signals (i.e., the BB frequency), and send the first modulated signals to the fifth amplifier 624e.

The fifth amplifier 624e may be configured to receive the first modulated signals from the third frequency mixer 620c, adjust an amplitude of the first modulated signals such that the amplified first modulated signals can drive the first frequency mixer 620a, and send the amplified first modulated signals to the first frequency mixer 620a.

The third amplifier 624c may be configured to receive the carrier signals from the signal distribution block (e.g., splitter) 628, adjust an amplitude of the carrier signals such that the amplified carrier signals can drive the first frequency mixer 620a, and send the amplified carrier signals to the first frequency mixer 620a.

The first frequency mixer 620a may be configured to receive the amplified carrier signals from the third amplifier 624c, receive the amplified first modulated signals from the fifth amplifier 624e, up-convert the amplified first modulated signals with the amplified carrier signals to produce second modulated signals having the data encoded therein and having the predetermined frequency of the amplified carrier signals (i.e., within the THz frequency band 104), and send the second modulated signals to the first amplifier 624a.

The first amplifier 624a may be configured to receive the second modulated signals from the first frequency mixer 620a, adjust an amplitude of the second modulated signals such that the amplified second modulated signals can be transmitted by the first RF interface 636a, and send the amplified second modulated signals to the first RF interface 636a.

The first RF interface 636a may be configured to receive the amplified second modulated signals from the first amplifier 624a and send the amplified second modulated signals as first transmission signals 644a (i.e., having the data encoded therein) having a frequency within a predetermined frequency range (e.g., the THz frequency band 104). In some implementations, the first RF interface 636a may be connected to the RF antenna 900 (shown in FIGS. 9A-9B, 10A-10J, 11, and 12A-12B) and configured to send the first transmission signals 644a to the RF antenna 900. In other implementations, however, the RF antenna 900 may be included in place of the first RF interface 636a, or the RF antenna 900 may be a part of the first RF interface 636a.

Referring now to the Rx circuitry 656b, the second RF interface 636b may be configured to receive the second transmission signals 644b (i.e., having data encoded therein) within a predetermined frequency range (e.g., the THz frequency band 104) and send the second transmission signals 644b to the second amplifier 624b. As described in further detail below, the second RF interface 636b may be configured to receive the second transmission signals 644b from the RF antenna 900 (shown in FIGS. 9A-9B, 10A-10J, 11, and 12A-12B). In other implementations, however, the RF antenna 900 may be included in place of the second RF interface 636b, or the RF antenna 900 may be a part of the second RF interface 636b.

The second amplifier 624b may be configured to receive the second transmission signals 644b from the second RF interface 636b, adjust an amplitude of the second transmission signals 644b such that the amplified second transmission signals can drive the second frequency mixer 620b, and send the amplified second transmission signals to the second frequency mixer 620b.

The fourth amplifier 624d may be configured to receive the carrier signals from the signal distribution block (e.g., splitter) 628, adjust an amplitude of the carrier signals such that the amplified carrier signals can drive the second frequency mixer 620b, and send the amplified carrier signals to the second frequency mixer 620b.

The second frequency mixer 620b may be configured to receive the amplified second transmission signals from the second amplifier 624b, receive the amplified carrier signals from the fourth amplifier 624d, down-convert the amplified second transmission signals with the amplified carrier signals to produce third modulated signals having the data encoded therein and having the BB frequency, and send the third modulated signals to the sixth amplifier 624f.

The sixth amplifier 624f may be configured to receive the third modulated signals from the second frequency mixer 620b, adjust an amplitude of the third modulated signals such that the amplified third modulated signals can drive the fourth frequency mixer 620d, and send the amplified third modulated signals to the fourth frequency mixer 620d.

The third LO 616c may be configured to generate second baseband signals having a continuous waveform (e.g., a sinusoidal waveform) having a predetermined frequency (i.e., a BB frequency). In some implementations, the predetermined frequency of the second baseband signals (i.e., the BB frequency) is in a range between 8 GHz and 10 GHz. The third LO 616c may be further configured to send the second baseband signals to the fourth frequency mixer 620d.

The fourth frequency mixer 620d may be configured to receive the amplified third modulated signals from the sixth amplifier 624f, receive the second baseband signals from the third LO 616c, down-convert the amplified third modulated signals with the second baseband signals to produce encoded output signals having the data encoded therein and having the predetermined frequency of the second baseband signals (i.e., the BB frequency), and send the encoded output signals to the modulation block 608.

The output interface 604b may be configured to transmit the output signals 640b indicative of data to one or more external component (e.g., a control module 224 of a network element 204). In some implementations, the output interface 604b is a pair of output interfaces. In some such implementations, the output interface 604b is a LVDS link configured to transmit LVDS signals, and the output signals 640b are LVDS signals indicative of data. In some implementations, the output signals 640b are encoded in a NRZ, NRZI, PAM, or PAM4 format.

The digital enhancement and control unit 632 may be configured to provide digital control and/or processing capabilities for one or more of the components of the first fiber-coupled RF transceiver 220a.

Referring now to FIG. 6B, shown therein is a block diagram of an exemplary implementation of a second fiber-coupled RF transceiver 220b (hereinafter the “multi-band transceiver 220b”) constructed in accordance with the present disclosure.

In the implementation shown, the multi-band transceiver 220b comprises an f₁ section 660-1 and an f₂ section 660-2. However, in other implementations, the multi-band transceiver 220b may comprise more than two sections.

The f₁ section 660-1 generally comprises an f₁ input interface 604a-1 configured to receive f₁ input signals 640a-1 from one or more external component (e.g., a control module 224 of a network element 204), first f₁ circuitry 656a-1 (hereinafter the “f₁ Tx circuitry 656a-1”) configured to generate f₁ RF signals 644a-1 (hereinafter the “first f₁ transmission signals 644a-1”) based on the f₁ input signals 640a-1, a first f₁ RF interface 636a-1 configured to transmit the first f₁ transmission signals 644a-1, a second f₁ RF interface 636b-1 configured to receive second f₁ transmission signals 644b-1, second f₁ circuitry 656b-1 (hereinafter the “f₁ Rx circuitry 656b-1”) configured to generate f₁ output signals 640b-1 based on the second f₁ transmission signals 644b-1, an f₁ output interface 604b-1 configured to transmit f₁ output signals 640b-1 to one or more external component (e.g., a control module 224 of a network element 204), and an f₁ digital enhancement and control unit 632-1. In some implementations, the first f₁ transmission signals 644a-1 and the second f₁ transmission signals 644b-1 have a first frequency f₁ within the THz frequency band 104.

In the implementation shown, the f₁ Tx circuitry 656a-1 comprises one or more f₁ modulation block 608-1 (hereinafter the “f₁ modulation block 608-1”), an f₁ frequency synthesizer 610-1 comprising an f₁ PLL 612-1, a first f₁ LO 616a-1, and an f₁ signal distribution block (e.g., splitter) 628-1, a second f₁ LO 616b-1, a first f₁ frequency mixer 620a-1, a third f₁ frequency mixer 620c-1, a first f₁ amplifier 624a-1, a third f₁ amplifier 624c-1, and a fifth f₁ amplifier 624e-1.

In the implementation shown, the f₁ Rx circuitry 656b-1 the f₁ modulation block 608-1, the f₁ frequency synthesizer 610-1, a third f₁ LO 616c-1, a second f₁ frequency mixer 620b-1, a fourth f₁ frequency mixer 620d-1, a second f₁ amplifier 624b-1, a f₁ fourth amplifier 624d-1, and a sixth f₁ amplifier 624f-1.

The f₂ section 660-2 generally comprises an f₂ input interface 604a-2 configured to receive f₂ input signals 640a-2 from one or more external component (e.g., a control module 224 of a network element 204), first f₂ circuitry 656a-2 (hereinafter the “f₂ Tx circuitry 656a-2”) configured to generate f₂ RF signals 644a-2 (hereinafter the “first f₂ transmission signals 644a-2”) based on the f₂ input signals 640a-2, a first f₂ RF interface 636a-2 configured to transmit the first f₂ transmission signals 644a-2, a second f₂ RF interface 636b-2 configured to receive second f₂ transmission signals 644b-2, second f₂ circuitry 656b-2 (hereinafter the “f₂ Rx circuitry 656b-2”) configured to generate f₂ output signals 640b-2 based on the second f₂ transmission signals 644b-2, an f₂ output interface 604b-2 configured to transmit f₂ output signals 640b-2 to one or more external component (e.g., a control module 224 of a network element 204), and an f₂ digital enhancement and control unit 632-2. In some implementations, the first f₂ transmission signals 644a-2 and the second f₂ transmission signals 644b-2 have a second frequency f₂ within the THz frequency band 104.

In the implementation shown, the f₂ Tx circuitry 656a-2 comprises one or more f₂ modulation block 608-2 (hereinafter the “f₂ modulation block 608-2”), an f₂ frequency synthesizer 610-2 comprising an f₂ PLL 612-2, a first f₂ LO 616a-2, and an f₂ signal distribution block (e.g., splitter) 628-2, a second f₂ LO 616b-2, a first f₂ frequency mixer 620a-2, a third f₂ frequency mixer 620c-2, a first f₂amplifier 624a-2, a third f₂ amplifier 624c-2, and a fifth f₂ amplifier 624e-2.

In the implementation shown, the f₂ Rx circuitry 656b-2 the f₂ modulation block 608-2, the f₂ frequency synthesizer 610-2, a third f₂ LO 616c-2, a second f₂ frequency mixer 620b-2, a fourth f₂ frequency mixer 620d-2, a second f₂ amplifier 624b-2, a f₂ fourth amplifier 624d-2, and a sixth f₂ amplifier 624f-2.

In some implementations, as shown in FIG. 6B, each of the components of the multi-band transceiver 220b are disposed on a single substrate 652a, which may be a portion of a semiconductor wafer. In some implementations, one or more of the components of the multi-band transceiver 220b are implemented using CMOS technology.

Referring now to FIG. 7, shown therein is a schematic diagram of an exemplary implementation of a folded modulator 700 constructed in accordance the present disclosure. As described above, in some implementations, the modulation block 408, 608, 608-1, 608-2 includes a folded modulator 700. In such implementations, the input signals 440, 640a, 640a-1, 640a-2 may be provided by the input interface 404, 604a, 604a-1, 604a-2 to the folded modulator 700, and the folded modulator 700 may provide the encoded signals to the frequency mixer 420b, 620c, 620c-1, 610c-2.

The folded modulator 700 may be configured to perform broadband direct modulation on the input signals 440, 640a, 640a-1, 640a-2 to generate the encoded signals and to minimize distortion while doing so. The folded modulator 700 may employ a cascade architecture (e.g., a cascaded circuit drive that is “stacked” or “folded”) in order to produce a linear or near-linear modulated output (i.e., the encoded signals). In implementations in which the folded modulator 700 employs a cascade architecture, the size of the stack may be directly proportional to the bandwidth.

Referring now to FIG. 8, shown therein is a schematic diagram of an exemplary implementation of a rectifying detector 800 constructed in accordance the present disclosure. As described above, in some implementations, the modulation block 508, 608, 608-1, 608-2 includes a rectifying detector 800. In such implementations, encoded signals may be provided by the frequency mixer 520b, 620d, 620d-1, 620d-2 to the rectifying detector 800, and the rectifying detector 800 may provide the output signals 540, 640b, 640b-1, 640b-2 to the output interface 504, 604b, 604b-1, 604b-2.

The rectifying detector 800 may be configured to perform direct detection of incoming signals (i.e., the encoded signals). The rectifying detector 800 may be further configured to detect an envelope of the encoded signals or one or more amplitude transition of the encoded signals to generate the output signals 540, 640b, 640b-1, 640b-2.

Referring now to FIG. 9A, shown therein is a side view of an exemplary implementation of a fiber-coupled RF antenna 900a (hereinafter, the “antenna 900a”) coupled with a passive waveguide 208 constructed in accordance with the present disclosure. The antenna 900a may be electrically connected to, included in place of, or a part of the RF interface 436 (shown in FIGS. 4A and 4B), the RF interface 536 (shown in FIGS. 5A and 5B), the first RF interface 636a (shown in FIG. 6A), the second RF interface 636b (shown in FIG. 6A), the first f₁ RF interface 636a-1 (shown in FIG. 6B), the second f₁ RF interface 636b-1 (shown in FIG. 6B), the first f₂ RF interface 636a-2 (shown in FIG. 6B), or the second f₂ RF interface 636b-2 (shown in FIG. 6B) described above.

As shown in FIG. 9A, the antenna 900a generally comprises a ground plane 904, a radiator 908 mounted on the ground plane 904, and a coaxial feedline 912 electrically connected to the radiator 908. In some implementations, the antenna 900a may lack the ground plane 904. In some implementations, the antenna 900a further comprises a casing (not shown) enclosing the radiator 908. The antenna 900a may be a vertical antenna (i.e., an antenna extending orthogonally from a substrate) or a horizontal antenna (i.e., an antenna extending laterally from a substrate).

The radiator 908 may be configured to emit and receive RF signals. In some implementations, the radiator 908 is configured to emit and receive RF signals in a single mode. In the implementation shown, the radiator 908 is a helical radiator configured to emit and receive circularly polarized RF signals. In this implementation, the radiator 908 has a length l_{radiator}, a diameter d_{radiator}, and a spacing s_{radiator} between adjacent turns of the radiator 908. The radiator 908 is preferably disposed at a distance d_{gap} from the passive waveguide 208.

The radiator 908 may be wound in a predetermined direction, such as clockwise (i.e., a left-hand wind) or counter-clockwise (i.e., a right-hand wind). While the radiator 908 of the antenna 900a is depicted in FIG. 9A as having a right-hand wind or a counter-clockwise rotational direction, it should be understood that the radiator 908 of the antenna 900a may be provided with a left-hand wind or a clockwise rotational direction.

In some implementations, RF signals for transmission may be sent to the antenna 900a via the coaxial feedline 912. In other implementations, received RF signals may be sent from the antenna 900a via the coaxial feedline 912.

In some implementations, the length l_{radiator} of the radiator 908 may be proportional to the wavelength of the signals being transmitted and/or received. In some implementations, the length l_{radiator} of the radiator 908 is in a range between 10 microns and 10 mm. In some implementations, the diameter d_{radiator} of the radiator 908 may be proportional to the wavelength of the signals being transmitted and/or received. In some implementations, the diameter d_{radiator} of the radiator 908 is in a range between 10 microns and 10 mm. In some implementations, the spacing s_{radiator} between adjacent turns of the radiator 908 may be in a range between 1 micron and 1 mm.

The predetermined distance d_{gap} at which the antenna 900 is spaced from the passive waveguide 208 may vary depending upon the carrier frequency of the RF signal being transmitted by the antenna 900. In some implementations, the predetermined distance d_{gap} at which the antenna 900 is spaced from the passive waveguide 208 is in a range between 3 μm and 3 mm. In one implementation, the predetermined distance d_{gap} at which the antenna 900 is spaced from the passive waveguide 208 is 1 mm.

In some implementations, the antenna 900a may be directly connected to the passive waveguide 208.

Referring now to FIG. 9B, shown therein is a top plan view of another exemplary implementation of a fiber-coupled RF antenna 900b (hereinafter, the “antenna 900b”) to be coupled with the passive waveguide 208 and constructed in accordance with the present disclosure. The antenna 900b may be electrically connected to, included in place of, or a part of the RF interface 436 (shown in FIGS. 4A and 4B), the RF interface 536 (shown in FIGS. 5A and 5B), the first RF interface 636a (shown in FIG. 6A), the second RF interface 636b (shown in FIG. 6A), the first f₁ RF interface 636a-1 (shown in FIG. 6B), the second f₁ RF interface 636b-1 (shown in FIG. 6B), the first f₂ RF interface 636a-2 (shown in FIG. 6B), or the second f₂ RF interface 636b-2 (shown in FIG. 6B) described above.

The antenna 900b is similar in construction and function as the antenna 900a, with the exception that the antenna 900b includes a radiator 908a formed of a conductive material having a plurality of coplanar windings. In one implementation, the radiator 908a is in the form of a spiral. The radiator 908a may be wound in a predetermined direction, such as clockwise (i.e., a left-hand wind) or counter-clockwise (i.e., a right-hand wind). While the radiator 908a of the antenna 900b is depicted in FIG. 9B as having a right-hand wind or a counter-clockwise rotational direction, it should be understood that the radiator 908a of the antenna 900b may be provided with a left-hand wind or a clockwise rotational direction.

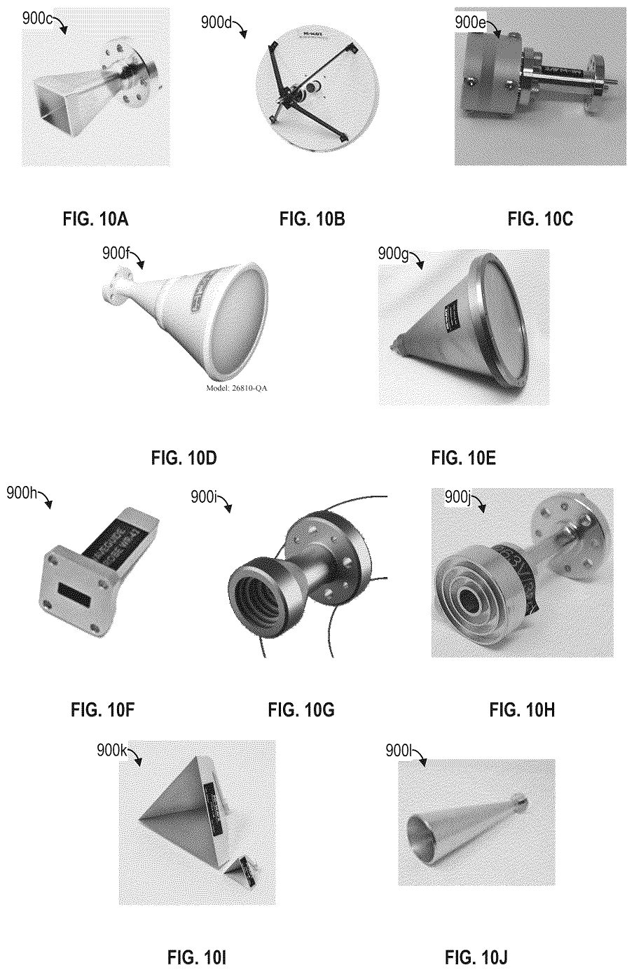

Referring now to FIGS. 10A-10J, shown therein are perspective views of other exemplary implementations of the antenna 900 shown in FIGS. 9A and 9B. As shown in FIGS. 10A-10J, other implementations of the antenna 900 include implementation as a gain horn antenna 900c (shown in FIG. 10A), a Cassegrain antenna 900d (shown in FIG. 10B), an omnidirectional antenna 900e (shown in FIG. 10C), a horn lens antenna 900f (shown in FIG. 10D), a spot focus antenna 900g (shown in FIG. 10E), a waveguide probe antenna 900h (shown in FIG. 10F), a scalar feed horn antenna 900i (shown in FIG. 10G), a wide-angle scalar feed horn antenna 900j (shown in FIG. 10H), a trihedral antenna 900k (shown in FIG. 10I), and a conical horn antenna 900l (shown in FIG. 10J). One or more of the antennas 900 may be electrically connected to, included in place of, or a part of the RF interface 436 (shown in FIGS. 4A and 4B), the RF interface 536 (shown in FIGS. 5A and 5B), the first RF interface 636a (shown in FIG. 6A), the second RF interface 636b (shown in FIG. 6A), the first f₁ RF interface 636a-1 (shown in FIG. 6B), the second f₁ RF interface 636b-1 (shown in FIG. 6B), the first f₂ RF interface 636a-2 (shown in FIG. 6B), or the second f₂ RF interface 636b-2 (shown in FIG. 6B) described above.

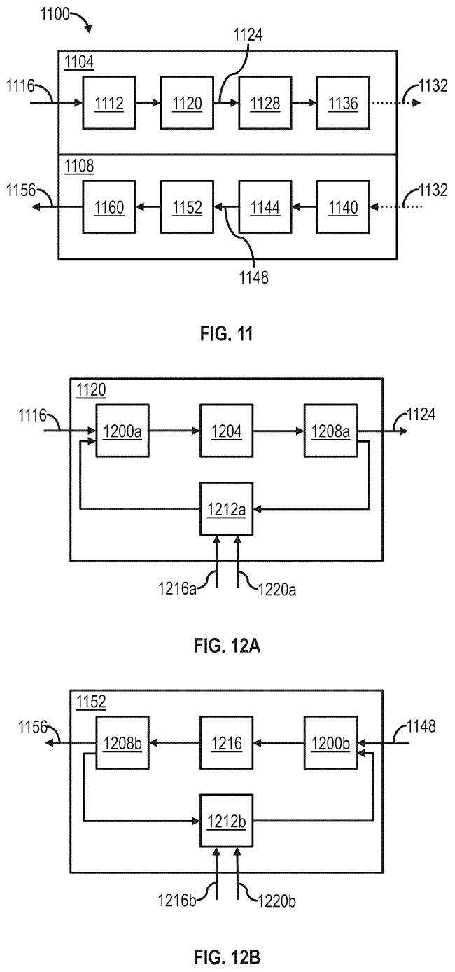

Referring now to FIG. 11, shown therein is an exemplary implementation of a network element 1100 configured to modulate data using differential quadrature phase shift keying (DQPSK) constructed in accordance with the present disclosure. In the implementation shown in FIG. 11, the network element 1100 comprises a transmitter 1104 and a receiver 1108. However, in other implementations, the network element 1100 may comprise only the transmitter 1104 or only the receiver 1108. In still other implementations, the network element 1100 may comprise a plurality of transmitters 1104 and/or a plurality of receivers 1108. The network element 1100 is generally configured to transmit and/or receive RF signals having a frequency in a range between 300 Gigahertz (GHz) and 10 Terahertz (THz).

The transmitter 1104 generally comprises an input interface 1112 configured to receive an input digital bitstream 1116 encoded in reflected binary code (RBC) and comprising a first plurality of symbols, a DQPSK encoder 1120 configured to encode each of the first plurality of symbols in a DQPSK format to produce a first DQPSK-encoded digital bitstream 1124 having a second plurality of symbols based on the first plurality of symbols and encoded in RBC, transmitter circuitry 1128 configured to generate a transmission signal 1132 based on the first DQPSK-encoded digital bitstream 1124, and a transmitter antenna 1136 configured to transmit the transmission signal 1132. In some implementations, the input interface 1112 is further configured to receive the input digital bitstream 1116 from another component of the network element 1100. In some implementations, the transmitter antenna 1136 is further configured to transmit the transmission signal 1132 into a passive waveguide 208 as described above.

The receiver 1108 generally comprises a receiver antenna 1140 configured to receive signals such as the transmission signal 1132, receiver circuitry 1144 configured to generate a second DQPSK-encoded digital bitstream 1148 encoded in RBC and comprising a third plurality of symbols based on the transmission signal 1132, a DQPSK decoder 1152 configured to decode each of the third symbols from the DQPSK format to produce an output digital bitstream 1156 having a fourth plurality of symbols based on the third symbols and encoded in RBC, and an output interface 1160 configured to transmit the output digital bitstream 1156. In some implementations, the receiver antenna 1140 is further configured to receive the transmission signal 1132 from a passive waveguide 208 as described above. In some implementations, the output interface 1160 is further configured to transmit the output digital bitstream 1156 to another component of the network element 1100.

Referring now to FIG. 12A, shown therein is an exemplary implementation of the DQPSK encoder 1120 shown in FIG. 11. As described above, the DQPSK encoder 1120 is generally configured to receive the input digital bitstream 1116 encoded in RBC and comprising the first plurality of symbols from the input interface 1112, encode each of the first plurality of symbols in a DQPSK format to produce the first DQPSK-encoded digital bitstream 1124 having the second plurality of symbols, and transmit the first DQPSK-encoded digital bitstream 1124 to the transmitter circuitry 1128. The DQPSK encoder 1120 generally comprises a first reflected-to-natural (R2N) binary converter 1200a, an adder 1204, a first natural-to-reflected (N2R) binary converter 1208a, and a first memory 1212a.

As described herein, the DQPSK encoder 1120 is configured to receive the first plurality of symbols in a serial manner in a series of cycles. That is, in a given cycle, the DQPSK encoder 1120 is configured to receive a particular one of the first plurality of symbols, which may be referred to as a “current” symbol during the cycle in which the symbol is received. Further, the DQPSK encoder 1120 is configured to store the current symbol in the first memory 1212a for use in the next cycle (i.e., the cycle after the current symbol is received), during which the symbol may be referred to as a “previous” symbol.

The first reflected-to-natural (R2N) binary converter 1200a is generally configured to convert the current symbol and the previous symbol into natural binary code (NBC). The adder 1204 is generally configured to add the current symbol and the previous symbol to produce a particular one of the second plurality of symbols. The first natural-to-reflected (N2R) binary converter 1208a is generally configured to convert the particular one of the second plurality of symbols into RBC.

Referring now to FIG. 12B, shown therein is an exemplary implementation of the DQPSK decoder 1152 shown in FIG. 11. As described above, the DQPSK decoder 1152 is generally configured to receive the second DQPSK-encoded digital bitstream 1148 encoded in RBC and comprising the third plurality of symbols from the receiver circuitry 1144, decode each of the third plurality of symbols from the DQPSK format to produce the output digital bitstream 1156 having the fourth plurality of symbols, and transmit the output digital bitstream to the output interface 1160. The DQPSK decoder 1152 generally comprises a second R2N binary converter 1200b, a subtractor 1216, a second N2R binary converter 1208b, and a second memory 1212b.

As described herein, the DQPSK decoder 1152 is configured to receive the third plurality of symbols in a serial manner in a series of cycles. That is, in a given cycle, the DQPSK decoder 1152 is configured to receive a particular one of the third plurality of symbols, which may be referred to as a “current” symbol during the cycle in which the symbol is received. Further, the DQPSK decoder 1152 is configured to store the current symbol in the second memory 1212b for use in the next cycle (i.e., the cycle after the current symbol is received), during which the symbol may be referred to as a “previous” symbol.

The second R2N binary converter 1200b is generally configured to convert the current symbol and the previous symbol into NBC. The subtractor 1216 is generally configured to subtract the previous symbol from the current symbol to produce a particular one of the fourth plurality of symbols. The second N2R binary converter 1208b is generally configured to convert the particular one of the fourth plurality of symbols into RBC.

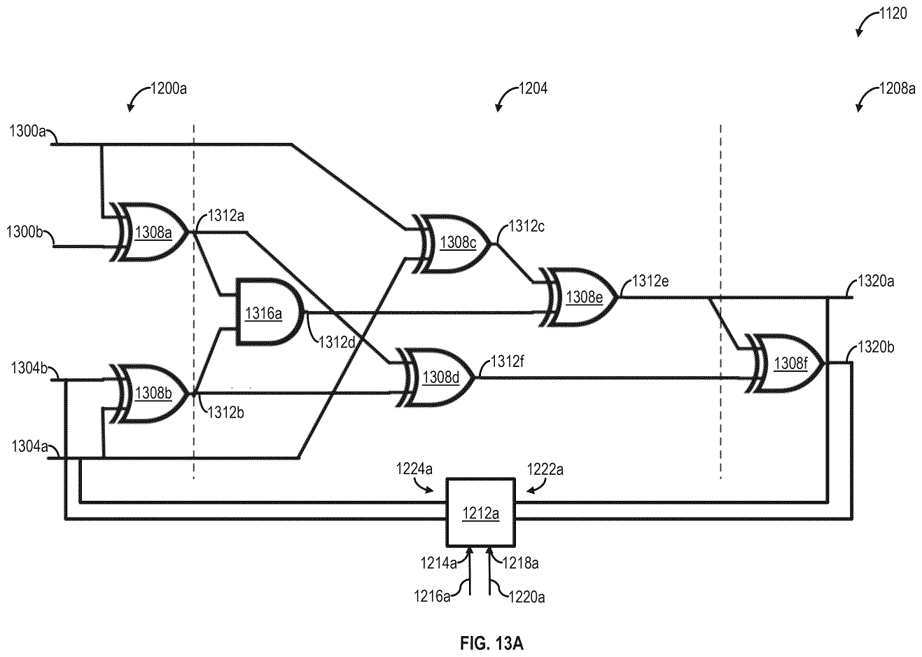

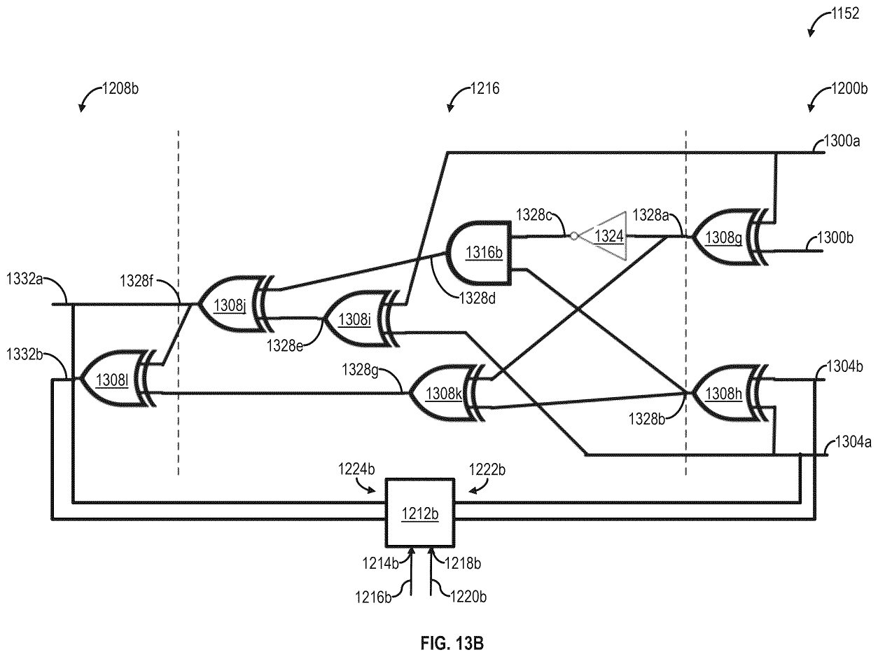

Referring now to FIG. 13A, shown therein is another representation of the DQPSK encoder 1120 shown in FIG. 12A. While each of the symbols are described herein as having two bits, it should be understood that one or more of the symbols may have a number of bits greater or less than two. Further, in some implementations, the DQPSK encoder 1120 may be constructed to have a particular propagation time to avoid race conditions. In other implementations, the DQPSK encoder 1120 may comprise one or more delay element configured to avoid such race conditions.

The first R2N binary converter 1200a may receive a first current bit 1300a and a second current bit 1300b of the current symbol and a first previous bit 1304a and a second previous bit 1304b of the previous symbol and may comprise one or more first logic gate including a first exclusive OR (XOR) gate 1308a and a second XOR gate 1308b. The first XOR gate 1308a may receive the first current bit 1300a and the second current bit 1300b and perform a XOR operation on the first current bit 1300a and the second current bit 1300b to produce a first encoder bit 1312a. The second XOR gate 1308b may receive the first previous bit 1304a and the second previous bit 1304b and perform a XOR operation on the first previous bit 1304a and the second previous bit 1304b to produce a second encoder bit 1312b.

The adder 1204 may receive the first current bit 1300a, the first encoder bit 1312a, the first previous bit 1304a, and the second encoder bit 1312b and may comprise one or more second logic gate including a third XOR gate 1308c, a fourth XOR gate 1308d, a fifth XOR gate 1308e, and a first AND gate 1316a. The third XOR gate may receive the first current bit 1300a and the first previous bit 1304a and perform a XOR operation on the first current bit 1300a and the first previous bit 1304a to produce a third encoder bit 1312c. The first AND gate 1316a may receive the first encoder bit 1312a and the second encoder bit 1312b and perform an AND operation on the first encoder bit 1312a and the second encoder bit 1312b to produce a fourth encoder bit 1312d. The fifth XOR gate 1308e may receive the third encoder bit 1312c and the fourth encoder bit 1312d and perform a XOR operation on the third encoder bit 1312c and the fourth encoder bit 1312d to produce a fifth encoder bit 1312e. The fourth XOR gate 1308d may receive the first encoder bit 1312a and the second encoder bit 1312b and perform a XOR operation on the first encoder bit 1312a and the second encoder bit 1312b to produce a sixth encoder bit 1312f.

The first N2R binary converter 1208a may receive the fifth encoder bit 1312e and the sixth encoder bit 1312f and may comprise one or more third logic gate including a sixth XOR gate 1308f. The first N2R binary converter 1208a may transmit the fifth encoder bit 1312e as a first encoded bit 1320a. The sixth XOR gate 1308f may receive the fifth encoder bit 1312e and the sixth encoder bit 1312f and perform a XOR operation on the fifth encoder bit 1312e and the sixth encoder bit 1312f to produce a second encoded bit 1320b.

The first memory 1212a may have a first clock input 1214a configured to receive a first clock signal 1216a periodically transitioning between a high state and a low state, a first enable input 1218a configured to receive a first enable signal 1220a (i.e., a clock recovered from a clock recovery circuit) having an inactive state and an active state, a first data input 1222a configured to receive the first encoded bit 1320a and the second encoded bit 1320b, and may be configured to, responsive to the first clock signal 1216a transitioning between the high state and the low state while the first enable signal 1220a is in the active state, store the first encoded bit 1320a and the second encoded bit 1320b as the previous symbol, and transmit the previous symbol from a first output 1224a while the first enable signal 1220a is in the inactive state. In some implementations, the first memory 1212a is a D flip-flop.

Referring now to FIG. 13B, shown therein is another representation of the DQPSK decoder 1152 shown in FIG. 12B. While each of the symbols are described herein as having two bits, it should be understood that one or more of the symbols may have a number of bits greater or less than two. Further, in some implementations, the DQPSK decoder 1152 may be constructed to have a particular propagation time to avoid race conditions. In other implementations, the DQPSK decoder 1152 may comprise one or more delay element configured to avoid such race conditions.

The second R2N binary converter 1200b may receive the first current bit 1300a and the second current bit 1300b of the current symbol and the first previous bit 1304a and the second previous bit 1304b of the previous symbol and may comprise one or more fourth logic gate including a seventh XOR gate 1308g and an eighth XOR gate 1308h. The seventh XOR gate 1308g may receive the first current bit 1300a and the second current bit 1300b and perform a XOR operation on the first current bit 1300a and the second current bit 1300b to produce a first decoder bit 1328a. The eighth XOR gate 1308h may receive the first previous bit 1304a and the second previous bit 1304b and perform a XOR operation on the first previous bit 1304a and the second previous bit 1304b to produce a second decoder bit 1328b.

The subtractor 1216 may receive the first current bit 1300a, the first decoder bit 1328a, the first previous bit 1304a, and the second decoder bit 1328b and may comprise one or more fifth logic gate including a NOT gate 1324, a second AND gate 1316b, a ninth XOR gate 1308i, a tenth XOR gate 1308j, and an eleventh XOR gate 1308k. The NOT gate 1324 may receive the first decoder bit 1328a and may perform a NOT operation (i.e., invert) the first decoder bit 1328a to produce a third decoder bit 1328c. The second AND gate 1316b may receive the second decoder bit 1328b and the third decoder bit 1328c and may perform an AND operation on the second decoder bit 1328b and the third decoder bit 1328c to produce a fourth decoder bit 1328d. The ninth XOR gate 1308i may receive the first current bit 1300a and the first previous bit 1304a and may perform a XOR operation on the first current bit 1300a and the first previous bit 1304a to produce a fifth decoder bit 1328e. The tenth XOR gate 1308j may receive the fourth decoder bit 1328d and the fifth decoder bit 1328e and may perform a XOR operation on the fourth decoder bit 1328d and the fifth decoder bit 1328e to produce a sixth decoder bit 1328f. The eleventh XOR gate 1308k may receive the first decoder bit 1328a and the second decoder bit 1328b and may perform a XOR operation on the first decoder bit 1328a and the second decoder bit 1328b to produce a seventh decoder bit 1328g.

The second N2R binary converter 1208b may receive the sixth decoder bit 1328f and the seventh decoder bit 1328g and may comprise one or more sixth logic gate including a twelfth XOR logic gate 1308l. The second N2R binary converter 1208b may transmit the sixth decoder bit 1328f as a first decoded bit 1332a. The twelfth XOR logic gate 1308l may receive the sixth decoder bit 1328f and the seventh decoder bit 1328g and may perform a XOR operation on the sixth decoder bit 1328f and the seventh decoder bit 1328g to produce a second decoded bit 1332b.

The second memory 1212b may have a second clock input 1214b configured to receive a second clock signal 1216b periodically transitioning between a high state and a low state, a second enable input 1218b configured to receive a second enable signal 1220b having an inactive state and an active state, a second data input 1222b configured to receive the first decoded bit 1332a and the second decoded bit 1332b, and may be configured to, responsive to the second clock signal 1216b transitioning between the high state and the low state while the second enable signal 1220b is in the active state, store the first decoded bit 1332a and the second decoded bit 1332b, and transmit the previous symbol from a second output 1224b while the second enable signal 1220b is in the inactive state. In some implementations, the second memory 1212b is a D flip-flop.

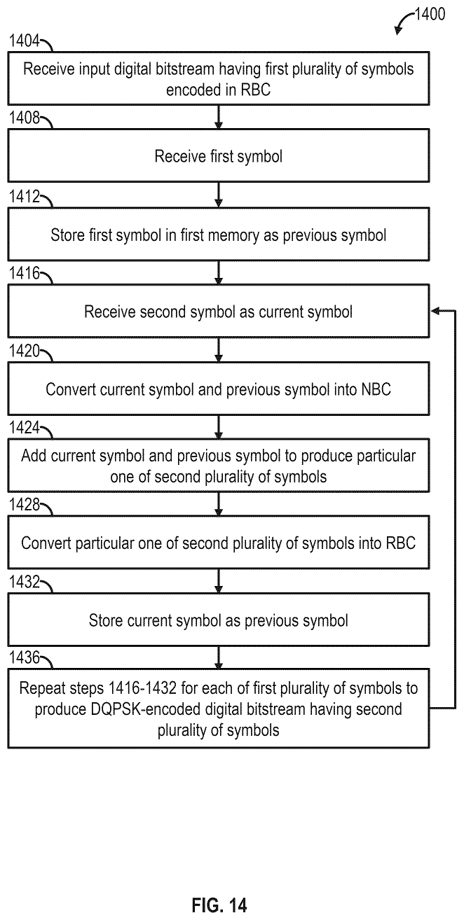

Referring now to FIG. 14, shown therein is a method 1400 of encoding data in a DQPSK format, generally comprising the steps of: receiving, with the DQPSK encoder 1120 of the transmitter 1104, the input digital bitstream 1116 encoded in RBC (step 1404); receiving the first symbol of the first plurality of symbols (step 1408); storing a first symbol in the first memory 1212a as the previous symbol (step 1412); receiving a second symbol of the first plurality of symbols as a current symbol (step 1416); converting the current symbol and the previous symbol into NBC (step 1420); adding the current symbol and the previous symbol to produce a particular one of the second plurality of symbols (step 1424); converting the particular one of the second plurality of symbols into RBC (step 1428); storing the current symbol in the first memory 1212a as the previous symbol (step 1432); and repeating steps 1416-1432 for each of the first plurality of symbols of the input digital bitstream 1116 to produce the first DQPSK-encoded digital bitstream 1124 having the second plurality of symbols encoded in RBC (step 1436).

In some implementations, the step of converting the current symbol and the previous symbol into NBC (step 1420) is further defined as converting, with the first R2N binary converter 1200a of the DQPSK encoder 1120, the current symbol and the previous symbol into NBC. In some such implementations, the step of converting the current symbol and the previous symbol into NBC (step 1420) is further defined as: receiving the first current bit 1300a and the second current bit 1300b of the current symbol; receiving the first previous bit 1304a and the second previous bit 1304b of the previous symbol; performing a XOR operation on the first current bit 1300a and the second current bit 1300b to produce the first encoder bit 1312a; and performing a XOR operation on the first previous bit 1304a and the second previous bit 1304b to produce the second encoder bit 1312b.

In some implementations, the step of adding the current symbol and the previous symbol to produce a particular one of the second plurality of symbols (step 1424) is further defined as adding, with the adder 1204 of the DQPSK encoder 1120, the current symbol and the previous symbol to produce a particular one of the second plurality of symbols (step 1424). In some such implementations, the step of adding the current symbol and the previous symbol to produce a particular one of the second plurality of symbols (step 1424) is further defined as: receiving the first current bit 1300a, the first encoder bit 1312a, the first previous bit 1304a, and the second encoder bit 1312b; performing a XOR operation on the first current bit 1300a and the first previous bit 1304a to produce the third encoder bit 1312c; performing an AND operation on the first encoder bit 1312a and the second encoder bit 1312b to produce the fourth encoder bit 1312d; performing a XOR operation on the third encoder bit 1312c and the fourth encoder bit 1312d to produce the fifth encoder bit 1312e; and performing a XOR operation on the first encoder bit 1312a and the second encoder bit 1312b to produce the sixth encoder bit 1312f.

In some implementations, the step of converting the particular one of the second plurality of symbols into RBC (step 1428) is further defined as converting, with the first N2R binary converter 1208a of the DQPSK encoder 1120, the particular one of the second plurality of symbols into RBC. In some such implementations, the step of converting the particular one of the second plurality of symbols into RBC (step 1428) is further defined as: receiving the fifth encoder bit 1312e and the sixth encoder bit 1312f; transmitting the fifth encoder bit 1312e as the first encoded bit 1320a; and performing a XOR operation on the fifth encoder bit 1312e and the sixth encoder bit 1312f to produce the second encoded bit 1320b.

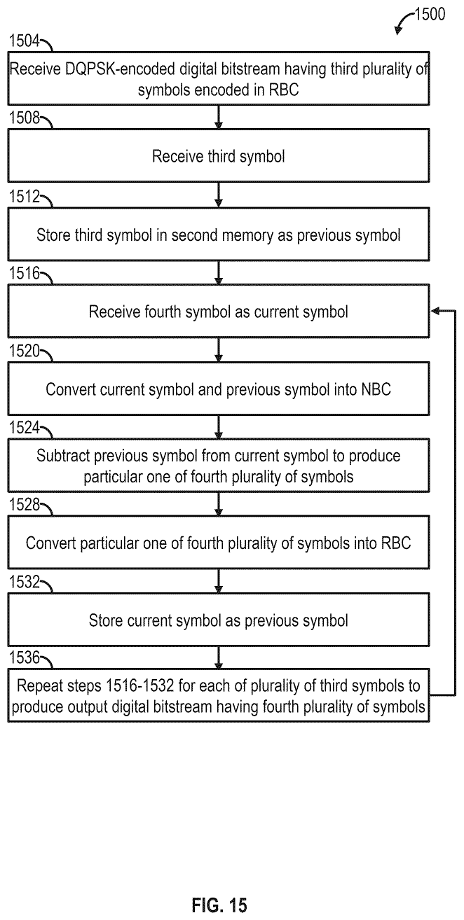

Referring now to FIG. 15, shown therein is a method 1500 of decoding data from a DQPSK format, generally comprising the steps of: receiving, with the DQPSK decoder 1152 of the receiver 1108, the second DQPSK-encoded digital bitstream 1148 encoded in RBC (step 1504); receiving a third symbol of the third plurality of symbols (step 1508); storing the third symbol in the second memory 1212b as a previous symbol (step 1512); receiving a fourth symbol of the third plurality of symbols as a current symbol (step 1516); converting the current symbol and the previous symbol into NBC (step 1520); subtracting the previous symbol from the current symbol to produce a particular one of a fourth plurality of symbols (step 1524); converting the particular one of the fourth plurality of symbols into RBC (step 1528); storing the current symbol in the second memory 1212b as the previous symbol (step 1532); and repeating steps 1516-1532 for each of the third plurality of symbols of the second DQPSK-encoded digital bitstream 1148 to produce the output digital bitstream 1156 having the fourth plurality of symbols encoded in RBC (step 1536).

In some implementations, the step of converting the current symbol and the previous symbol into NBC (step 1520) is further defined as converting, with the second R2N binary converter 1200b of the DQPSK decoder 1152, converting the current symbol and the previous symbol into NBC (step 1520). In some such implementations, the step of converting the current symbol and the previous symbol into NBC (step 1520) is further defined as: receiving the first current bit 1300a and the second current bit 1300b of the current symbol and the first previous bit 1304a and the second previous bit 1304b of the previous symbol; performing XOR operation on the first current bit 1300a and the second current bit 1300b to produce the first decoder bit 1328a; and performing a XOR operation on the first previous bit 1304a and the second previous bit 1304b to produce the second decoder bit 1328b.

In some implementations, the step of subtracting the previous symbol from the current symbol to produce a particular one of a fourth plurality of symbols (step 1524) is further defined as subtracting, with the subtractor 1216 of the DQPSK decoder 1152, the previous symbol from the current symbol to produce a particular one of a fourth plurality of symbols. In some such implementations, the step of subtracting the previous symbol from the current symbol to produce a particular one of a fourth plurality of symbols (step 1524) is further defined as: receiving the first current bit 1300a, the first decoder bit 1328a, the first previous bit 1304a, and the second decoder bit 1328b; performing a NOT operation (i.e., inverting) the first decoder bit 1328a to produce the third decoder bit 1328c; performing an AND operation on the second decoder bit 1328b and the third decoder bit 1328c to produce the fourth decoder bit 1328d; performing a XOR operation on the first current bit 1300a and the first previous bit 1304a to produce the fifth decoder bit 1328e; performing a XOR operation on the fourth decoder bit 1328d and the fifth decoder bit 1328e to produce the sixth decoder bit 1328f; and performing a XOR operation on the first decoder bit 1328a and the second decoder bit 1328b to produce the seventh decoder bit 1328g.

In some implementations, the step of converting the particular one of the fourth plurality of symbols into RBC (step 1528) is further defined as converting, with the second N2R binary converter 1208b of the DQPSK decoder 1152, the particular one of the fourth plurality of symbols into RBC. In some such implementations, the step of converting the particular one of the fourth plurality of symbols into RBC (step 1528) is further defined as: receiving the sixth decoder bit 1328f and the seventh decoder bit 1328g; transmitting the sixth decoder bit 1328f as the first decoded bit 1332a; and performing a XOR operation on the sixth decoder bit 1328f and the seventh decoder bit 1328g to produce a second decoded bit 1332b.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A radio frequency (RF) transmitter, comprising:
an input interface configured to receive an input digital bitstream encoded in a reflected binary code, the reflected binary code being an encoding of numbers such that successive numbers differ by only one bit, the input digital bitstream comprising a first plurality of symbols;
a differential quadrature phase shift keying (DQPSK) encoder having a memory, the DQPSK encoder configured to:
(a) receive a first symbol of the first plurality of symbols;
(b) store the first symbol in the memory as a previous symbol;
(c) receive a second symbol of the first plurality of symbols as a current symbol;
(d) convert the current symbol and the previous symbol into a natural binary code;
(e) add the current symbol and the previous symbol to produce a particular one of a second plurality of symbols;
(f) convert the particular one of the second plurality of symbols into the reflected binary code; and
(g) store the current symbol in the memory as the previous symbol; and
(h) repeat steps (c)-(g) for each of the first plurality of symbols to produce a DQPSK-encoded digital bitstream having the second plurality of symbols encoded in the reflected binary code;
circuitry configured to generate a transmission signal based on the DQPSK-encoded digital bitstream, wherein the transmission signal is an RF signal having a frequency in a range between 300 Gigahertz (GHz) and 10 Terahertz (THz); and
an antenna configured to transmit the transmission signal.

2. The RF transmitter of claim 1, wherein the DQPSK encoder comprises a reflected-to-natural binary converter configured to perform step (d), an adder configured to perform step (e), and a natural-to-reflected binary converter configured to perform step (f).

3. The RF transmitter of claim 2, wherein the reflected-to-natural binary converter comprises one or more logic gate configured to:
receive a first bit and a second bit of the current symbol;
receive a third bit and a fourth bit of the previous symbol;
perform an exclusive OR (XOR) operation on the first bit and the second bit to produce a fifth bit; and
perform an XOR operation on the third bit and the fourth bit to produce a sixth bit;
wherein the current symbol in the natural binary code comprises the first bit and the fifth bit; and
wherein the previous symbol in the natural binary code comprises the third bit and the sixth bit.

4. The RF transmitter of claim 3, wherein the one or more logic gate is one or more first logic gate, and wherein the adder comprises one or more second logic gate configured to:
receive the first bit and the fifth bit of the current symbol in the natural binary code;
receive the third bit and the sixth bit of the previous symbol in the natural binary code;
perform an XOR operation on the first bit and the third bit to produce a seventh bit;
perform an AND operation on the fifth bit and the sixth bit to produce an eighth bit;
perform an XOR operation on the seventh bit and the eighth bit to produce a ninth bit; and
perform an XOR operation on the fifth bit and the sixth bit to produce a tenth bit; and
wherein the particular one of the second plurality of symbols comprises the ninth bit and the tenth bit.

5. The RF transmitter of claim 4, wherein the natural-to-reflected binary converter comprises one or more third logic gate configured to:
receive the ninth bit and the tenth bit of the particular one of the second plurality of symbols; and
perform an XOR operation on the ninth bit and the tenth bit to produce an eleventh bit; and
wherein the particular one of the second plurality of symbols in the reflected binary code comprises the ninth bit and the eleventh bit.

6. The RF transmitter of claim 2, wherein the memory is configured to:
receive a clock signal periodically transitioning between a high state and a low state;
receive an enable signal having an inactive state and an active state;
receive the previous symbol;
responsive to the clock signal transitioning between the high state and the low state while the enable signal is in the active state, store the previous symbol; and
transmit the previous symbol while the enable signal is in the inactive state.

7. A radio frequency (RF) receiver, comprising:
an antenna configured to receive a transmission signal, wherein the transmission signal is an RF signal having a frequency in a range between 300 Gigahertz (GHz) and 10 Terahertz (THz);
circuitry configured to generate a differential quadrature phase shift keying (DQPSK)-encoded digital bitstream based on the transmission signal, the DQPSK-encoded digital bitstream encoded in a reflected binary code and comprising a first plurality of symbols, the reflected binary code being an encoding of numbers such that successive numbers differ by only one bit;
a DQPSK decoder having a memory, the DQPSK decoder configured to:
(a) receive a previous symbol of the first plurality of symbols;
(b) store the previous symbol in the memory;
(c) receive a current symbol of the first plurality of symbols;
(d) convert the current symbol and the previous symbol into a natural binary code;
(e) subtract the previous symbol from the current symbol to produce a particular one of a second plurality of symbols;
(f) convert the particular one of the second plurality of symbols into the reflected binary code;
(g) store the current symbol in the memory as the previous symbol; and
(h) repeat steps (c)-(g) for each of the first plurality of symbols of the DQPSK-encoded digital bitstream to produce an output digital bitstream having the second plurality of symbols encoded in the reflected binary code; and
an output interface configured to transmit the output digital bitstream.

8. The RF receiver of claim 7, wherein the DQPSK decoder comprises a reflected-to-natural binary converter configured to perform step (d), a subtractor configured to perform step (e), and a natural-to-reflected binary converter configured to perform step (f).

9. The RF receiver of claim 8, wherein the reflected-to-natural binary converter comprises one or more logic gate configured to:
receive a first bit and a second bit of the current symbol;
receive a third bit and a fourth bit of the previous symbol;
perform an exclusive OR (XOR) operation on the first bit and the second bit to produce a fifth bit; and
perform an XOR operation on the third bit and the fourth bit to produce a sixth bit;
wherein the current symbol in the natural binary code comprises the first bit and the fifth bit; and
wherein the previous symbol in the natural binary code comprises the third bit and the sixth bit.

10. The RF receiver of claim 9, wherein the one or more logic gate is one or more first logic gate, and wherein the subtractor comprises one or more second logic gate configured to:
receive the first bit and the fifth bit of the current symbol in the natural binary code;
receive the third bit and the sixth bit of the previous symbol in the natural binary code;
perform a NOT operation on the fifth bit to produce a seventh bit;
perform an AND operation on the sixth bit and the seventh bit to produce an eighth bit;
perform an XOR operation on the first bit and the third bit to produce a ninth bit;
perform an XOR operation on the eighth bit and the ninth bit to produce a tenth bit; and
perform an XOR operation on the fifth bit and the sixth bit to produce an eleventh bit; and
wherein the particular one of the second plurality of symbols comprises the tenth bit and the eleventh bit.

11. The RF receiver of claim 10, wherein the natural-to-reflected binary converter comprises one or more third logic gate configured to:
receive the tenth bit and the eleventh bit of the particular one of the second plurality of symbols; and
perform an XOR operation on the tenth bit and the eleventh bit to produce a twelfth bit; and
wherein the particular one of the second plurality of symbols in the reflected binary code comprises the tenth bit and the twelfth bit.

12. The RF receiver of claim 8, wherein the memory has a data input, a clock input configured to receive a clock signal periodically transitioning between a high state and a low state, an enable input configured to receive an enable signal having an inactive state and an active state, and an output, the memory configured to:
receive the previous symbol;
responsive to the clock signal transitioning between the high state and the low state when the enable signal is in the active state, store the previous symbol; and
maintain the previous symbol at the output while the enable signal is in the inactive state.

13. A method, comprising:
(a) receiving, with a differential quadrature phase shift keying (DQPSK) encoder of a radio frequency (RF) transmitter, an input digital bitstream encoded in a reflected binary code, the reflected binary code being an encoding of numbers such that successive numbers differ by only one bit, the input digital bitstream comprising a first plurality of symbols, the DQPSK encoder having a memory;
(b) receiving a first symbol of the first plurality of symbols;
(c) storing the first symbol in the memory as a previous symbol;
(d) receiving a second symbol of the first plurality of symbols as a current symbol;
(e) converting the current symbol and the previous symbol into a natural binary code;
(f) adding the current symbol and the previous symbol to produce a particular one of a second plurality of symbols;
(g) converting the particular one of the second plurality of symbols into the reflected binary code;
(h) storing the current symbol in the memory as the previous symbol; and
(i) repeating steps (d)-(h) for each of the first plurality of symbols of the input digital bitstream to produce a DQPSK-encoded digital bitstream having the second plurality of symbols encoded in the reflected binary code.

14. The method of claim 13, further comprising:
wherein step (e) is further defined as (e) converting, with a reflected-to-natural binary converter of the DQPSK encoder, the current symbol and the previous symbol into the natural binary code;
wherein step (f) is further defined as (f) adding, with an adder of the DQPSK encoder, the current symbol and the previous symbol to produce a particular one of the second plurality of symbols; and
wherein step (g) is further defined as: (g) converting, with a natural-to-reflected binary converter of the DQPSK encoder, the particular one of the second plurality of symbols into the reflected binary code.

15. The method of claim 14, wherein step (e) is further defined as, with one or more logic gate of the reflected-to-natural binary converter:
receiving a first bit and a second bit of the current symbol;
receiving a third bit and a fourth bit of the previous symbol;
performing an exclusive OR (XOR) operation on the first bit and the second bit to produce a fifth bit; and
performing an XOR operation on the third bit and the fourth bit to produce a sixth bit;
wherein the current symbol in the natural binary code comprises the first bit and the fifth bit; and
wherein the previous symbol in the natural binary code comprises the third bit and the sixth bit.

16. The method of claim 15, wherein the one or more logic gate is one or more first logic gate, and wherein step (f) is further defined as, with one or more second logic gate of the adder:
receive the first bit and the fifth bit of the current symbol in the natural binary code;
receive the third bit and the sixth bit of the previous symbol in the natural binary code;
perform an XOR operation on the first bit and the third bit to produce a seventh bit;
perform an AND operation on the fifth bit and the sixth bit to produce an eighth bit;
perform an XOR operation on the seventh bit and the eighth bit to produce a ninth bit; and
perform an XOR operation on the fifth bit and the sixth bit to produce a tenth bit; and
wherein the particular one of the second plurality of symbols comprises the ninth bit and the tenth bit.

17. The method of claim 16, wherein step (g) is further defined as, with one or more third logic gate of the natural-to-reflected binary converter:
receiving the ninth bit and the tenth bit of the particular one of the second plurality of symbols; and
performing an XOR operation on the ninth bit and the tenth bit to produce an eleventh bit; and
wherein the particular one of the second plurality of symbols in the reflected binary code comprises the ninth bit and the eleventh bit.

18. A method, comprising:
(a) receiving, with a DQPSK decoder of a radio frequency (RF) receiver, a DQPSK-encoded digital bitstream encoded in a reflected binary code and comprising a first plurality of symbols, the reflected binary code being an encoding of numbers such that successive numbers differ by only one bit, the DQPSK decoder having a memory;
(b) receiving a first symbol of the first plurality of symbols;
(c) storing the first symbol in the memory as a previous symbol;
(d) receiving a second symbol of the first plurality of symbols as a current symbol;
(e) converting the current symbol and the previous symbol into natural binary code;
(f) subtracting the previous symbol from the current symbol to produce a particular one of a second plurality of symbols;
(g) converting the particular one of the second plurality of symbols into the reflected binary code;
(h) storing the current symbol in the memory as the previous symbol; and
(i) repeating steps (d)-(h) for each of the first plurality of symbols of the DQPSK-encoded digital bitstream to produce an output digital bitstream having the second plurality of symbols encoded in the reflected binary code.

19. The method of claim 18, further comprising:
wherein step (e) is further defined as (e) converting, with a reflected-to-natural binary converter of the DQPSK decoder, the current symbol and the previous symbol into the natural binary code;
wherein step (f) is further defined as: (f) adding, with a subtractor of the DQPSK decoder, the current symbol and the previous symbol to produce a particular one of the second plurality of symbols; and
wherein step (g) is further defined as: (g) converting, with a natural-to-reflected binary converter of the DQPSK decoder, the particular one of the second plurality of symbols into the reflected binary code.

20. The method of claim 19, wherein step (e) is further defined as, with one or more logic gate of the reflected-to-natural binary converter:
receiving a first bit and a second bit of the current symbol;
receiving a third bit and a fourth bit of the previous symbol;
performing an exclusive OR (XOR) operation on the first bit and the second bit to produce a fifth bit; and
perform an XOR operation on the third bit and the fourth bit to produce a sixth bit;
wherein the current symbol in the natural binary code comprises the first bit and the fifth bit; and
wherein the previous symbol in the natural binary code comprises the third bit and the sixth bit.

21. The method of claim 20, wherein the one or more logic gate are one or more first logic gate, and wherein step (f) is further defined as, with one or more second logic gate of the subtractor:
receiving the first bit and the fifth bit of the current symbol in the natural binary code;
receiving the third bit and the sixth bit of the previous symbol in the natural binary code;
performing a NOT operation on the fifth bit to produce a seventh bit;
performing an AND operation on the sixth bit and the seventh bit to produce an eighth bit;
performing an XOR operation on the first bit and the third bit to produce a ninth bit;
performing an XOR operation on the eighth bit and the ninth bit to produce a tenth bit; and
performing an XOR operation on the fifth bit and the sixth bit to produce an eleventh bit; and
wherein the particular one of the second plurality of symbols comprises the tenth bit and the eleventh bit.

22. The method of claim 21, wherein step (g) is further defined as, with one or more third logic gate of the natural-to-reflected binary converter:
receiving the tenth bit and the eleventh bit of the particular one of the second plurality of symbols; and
performing an XOR operation on the tenth bit and the eleventh bit to produce a twelfth bit; and
wherein the particular one of the second plurality of symbols in the reflected binary code comprises the tenth bit and the twelfth bit.
